(19) United States
(12) Patent Application Publication
(10) Pub. No.: US 2015/0304459 A1
(43) Pub. Date: Oct. 22, 2015

(54) METHOD AND SYSTEM OF TRANSMITTING DATA OVER A NETWORK USING A COMMUNICATION PROTOCOL

(71) Applicant: PIXIA CORP., Reston, VA (US)

(72) Inventors: Scott L. Pakula, Chantilly, VA (US); Rudolf O. ERNST, Leesburg, VA (US)

(73) Assignee: PIXIA CORP.

(21) Appl. No.: 14/688,247

(22) Filed: Apr. 16, 2015

Related U.S. Application Data
(60) Provisional application No. 61/980,345, filed on Apr. 16, 2014.

(51) Int. Cl. H04L 29/06; H04L 29/08

(52) U.S. Cl. CPC H04L 69/08; H04L 67/02; H04L 67/10; H04L 67/42

(57) ABSTRACT

A method of transmitting data over a network includes receiving, by a Non-Traditional HTTP server, a request from a Non-Traditional HTTP client through a network, the Non-Traditional HTTP server being configured to operate as a HTTP server that does not use TCP, the Non-Traditional HTTP client being configured to operate as a HTTP client that does not use TCP, the Non-Traditional HTTP server and the Non-Traditional HTTP client communicating through the network using User Space Transport Protocol (UsTP); and determining by the Non-Traditional HTTP server whether the request is valid. If the request is determined to be invalid, sending, by the Non-Traditional HTTP server, an error message to the Non-Traditional HTTP client through the network over UsTP. If the request is determined to be valid, sending by the Non-Traditional HTTP server, requested data to the Non-Traditional HTTP client through the network over UsTP.

### CROSS REFERENCE TO RELATED APPLICATIONS

The present patent application claims priority from U.S. provisional patent application No. 61/980,345 filed on Apr. 16, 2014, the entire content of which is incorporated herein by reference.

### BACKGROUND OF THE INVENTION

1. Field of the Invention

The present invention relates to method and system of transmitting data over a network using a communication protocol.

2. Discussion of Related Art

A client and a server can be computer software programs that run on a computer system (computer). A computer system can be a physical computer device such as a desktop computer, a server computer, a laptop computer, a tablet, a mobile phone, a field programmable gate array (FPGA), or a virtual computer device, for example a Virtual Machine (VM). The client and server programs can be configured to run on a same physical computer device or distinct computer devices. In addition, a client may be configured to run on one or more computer devices. Furthermore, a server may also be configured to run on one or more computer devices. A client and a server may exist within the same computer software program simultaneously. The computer devices or computer systems running clients and servers are connected to each other in some form over a network.

In general, a computer system or computer device runs an operating system (e.g., operating software) or OS. Examples of an operating system (OS) include WINDOWS®, LINUX, FREEBSD, APPLE iOS or Berkeley Operating system for Re-Programmable Hardware (BORPH). An operating system provides a socket interface to allow for inter-process communication (IPC) or communication between computer systems. For example, client and server computer software programs use the Portable Operating System Interface (POSIX) Berkeley sockets to exchange data. Client and server computer programs can also use (BSD sockets) application program interface (API) also known as the operating system socket interface to exchange data.

Exchanging data between a client and a server is commonly performed through a network. A client communicates with a server over a Local Area Network (LAN), Wide Area Network (WAN) or the Internet. Data is sent in packets using a transport or communication protocol such as Transmission Control Protocol (TCP), User Datagram Protocol (UDP), or Raw Socket Communication (RSC). Applications such as web browsers (e.g., MICROSOFT INTERNET EXPLORER, GOGGLE CHROME, MOZILLA FIREFOX, APPLE SAFARI, etc. . . . ) and web servers use a communication protocol such as Hypertext Transfer Protocol (HTTP), Hypertext Transfer Protocol Secure (HTTPS) which is a defined syntax on top of the TCP transport protocol.

A communication protocol uses one or many transport protocols that provide syntax to exchange data between a client and a server in a computer system. A transport protocol (e.g., TCP or UDP) specifies a source and destination port number in their packet header. In the case of raw socket communication, this is implementation specific. However, a port number is commonly a 16-bit unsigned integer ranging from 0 to 65535. For TCP, port number 0 is reserved and cannot be used. For UDP the source port is optional in which case a value of zero is assigned implying no port. The source port is used in conjunction with an IP address such as Internet Protocol version 4 (IPv4) and Internet Protocol version 6 (IPv6). When using TCP in conjunction with IPv4 or IPv6, it would be commonly referenced as TCP/IP.

A communication protocol use transport protocols with one or many port numbers. The Internet Assigned Number Authority (IANA) is responsible for maintaining the official assignment of port numbers for specific uses. However, many unofficial uses of both well-known and registered port numbers occur in practice. Some examples of official communication protocols are such as File Transfer Protocol (FTP) which is officially assigned by IANA TCP port 20 for data transfer and port 21 for control. IANA has officially assigned TCP and UDP port 22 for Secure Shell (SSH). TCP port 80 is officially assigned for Hypertext Transport Protocol (HTTP), and TCP port 443 is officially assigned for Hypertext Transfer Protocol over TLS/SSL (HTTPS).

The HTTP protocol is a popular communication protocol and a well-known standard. It is commonly used on a computer network, for example LAN, WAN and the Internet or World Wide Web (WWW). A current HTTP protocol version is HTTP 1.1 and is described in the Internet Engineering Task Force (IETF) RFC 2616 as well as RFC 2068 and the World Wide Web Consortium (W3C). There are also older versions of the HTTP protocol such as HTTP 0.9 or HTTP 1.0 which is referenced in RFC 1945. In addition, an extension to support the HTTP PATCH method is explained in RFC 5789. An extension to the HTTP 1.1 protocol is HTTP 1.1 WebDAV. This protocol is described in IETF RFC 4918. HTTPS is a communications protocol for secure HTTP communications over a computer network and is described in RFC 2818. It is implemented by layering the HTTP on top of the Secure Socket Layer/Transport Layer Security (SSL/TLS) protocol, thus adding security capabilities of SSL/TLS to standard HTTP communications. HTTP, HTTPS, Traditional HTTP client, Traditional HTTP server, Non-Traditional HTTP client, or Non-Traditional HTTP server are referred to herein as operating to the above specifications unless described otherwise.

The Common Gateway Interface (CGI) is a simple interface for running external programs, software or gateways under an HTTP server in a platform-independent manner. CGI is defined in RFC 3875 which defines Request Meta-Variables which include CONTENT_LENGTH, CONTENT_TYPE, etc, which is discussed herein. HTTP, HTTPS, Traditional HTTP client, Traditional HTTP server, Non-Traditional HTTP client, or Non-Traditional HTTP server are referred to herein as operating to the above specifications unless described otherwise.

Transport protocols not only provide a method of sending data packets between a client and server but also have a defined syntax to describe the data that is being transmitted. Therefore, a communication protocol, such as HTTP or HTTPS, has a defined syntax that allows exchange of complex data, Commonly, HTTP or HTTPS is utilized with the transport protocol of TCP. This is defined herein as Traditional HTTP. However, HTTP or HTTPS protocol only presumes a reliable transport protocol. Therefore, any transport protocol that provides such guarantees can be used, Any HTTP or HTTPS client or server that does not use the TCP transport protocol is defined herein as Non-Traditional HTTP.

Traditional HTTP is commonly used by any computer system. It is common that an operating system provides a web browser, which is a Traditional HTTP client. Many conventional web browsers such as MICROSOFT INTERNET EXPLORER, GOGGLE CHROME, MOZILLA FIREFOX, APPLE SAFARI, etc. can connect to a Traditional HTTP server. However, there may be many other web browsers that can connect to a Traditional HTTP Server.

Traditional HTTP servers can be provided on any computer system or computer device. However, Traditional HTTP servers are commonly used on server computers. Some of the common web servers are the Apache Web Server, Apache Tomcat, and Microsoft Internet Information Services.

Common problems that occur in any network can be due to high latency and/or packet loss. Latency is also referred to as round trip time (RTT). RTT is defined as the time period it takes for a signal to be sent plus the time period it takes for an acknowledgement of that signal to be received. RTT is commonly determined or measured by using the ping method between a client and a server on a network. A transport protocol sends a plurality of packets across a network. Packet loss occurs when one or more packets of data travelling across a network fail to reach their destination. For example, a transcontinental network may have a RTT of 250 milliseconds (ms) and a total bandwidth of 45 Megabits (Mbps). The maximum amount of bandwidth that a client and a server can achieve using the TCP transport protocol may be limited due to latency and other factors. In some instances, only 10% of the theoretical total bandwidth can be achieved during data transfer. In addition, in a network, it is possible that only 80% of the packets that are transmitted between a client and a server arrive successfully (this is referred to as 20% packet loss). The packet loss would further reduce the maximum amount bandwidth of a network. A Long Fat Network (LFN) is defined herein as a network that has relatively high latency (round trip time RTT is 100 ms or greater). In addition to having a relatively high RTT (RTT equal to or greater than 100 ms), a LFN may also have packet loss.

Traditional HTTP performance issues on LFN are a known issue due to TCP's Additive-Increase-Multiplicative-Decrease (AIMD) congestion avoidance algorithm (CCA). To ensure reliability, a server waits for an acknowledgement (ACK) for the byte-range sent to the client and when not received it will resend the packet after a particular interval. This is known as Automatic Repeat reQuest (ARQ) described in IETF RFC 3366.

One problem with Traditional HTTP client and Traditional HTTP server communication in a LFN with for example 300 ms round-trip time delay and/or 20% packet loss is that data transfer speeds becomes much slower. For example, in a Traditional HTTP client and a Traditional HTTP server that communicate over a 100 Megabit (Mb) network, the maximum theoretical throughput would be 12.5 Megabytes per second (MB/s) (i.e., 100 Mbps/8 bits per byte=12.5 MB/s). However, when taking into account the 300 ms of latency in this network and performing a Traditional HTTP GET request for 10 GB worth of data, the average throughput would be approximately less than 1 MB/s.

### BRIEF SUMMARY OF THE INVENTION

An aspect of the present invention is to provide a system of transmitting or receiving data over a network. The system includes a Non-Traditional HTTP client configured to communicate through a network using User Space Transport Protocol (UsTP), the Non-Traditional HTTP client being configured to operate as a HTTP or HTTPS client that does not use Transmission Control Protocol (TCP) for transmitting or receiving data. The system further includes a Non-Traditional HTTP server configured to communicate with the Non-Traditional HTTP client through the network using the User Space Transport Protocol (UsTP), the Non-Traditional HTTP server being configured to operate as a HTTP or HTTPS server that does not use Transmission Control Protocol (TCP) for transmitting or receiving data. In the system, a communication between the Non-Traditional HTTP client and the Non-Traditional server through the network using User Space Transport Protocol (UsTP) is established with a bandwidth greater than a bandwidth that is achieved using TCP.

In one embodiment, the Non-Traditional HTTP client is further configured to operate as a Traditional HTTP server, the Traditional HTTP server being configured to operate as a HTTP or HTTPS server that uses Transmission Control Protocol (TCP) for transmitting data to or receiving data from a Traditional HTTP client. The Traditional HTTP client being configured to operate as a HTTP or HTTPS client that uses Transmission Control Protocol (TCP) for transmitting and receiving data.

Another aspect of the present invention is to provide a system of transmitting and receiving data over a network. The system includes a plurality of Non-Traditional HTTP clients configured to communicate through a network using User Space Transport Protocol (UsTP), the plurality of Non-Traditional HTTP clients being configured to operate as HTTP or HTTPS clients that do not use Transmission Control Protocol (TCP) for transmitting or receiving data. The system also includes a plurality of Non-Traditional HTTP servers configured to communicate with the plurality of Non-Traditional HTTP clients through the network using the User Space Transport Protocol (UsTP), the plurality of Non-Traditional HTTP servers being configured to operate as HTTP or HTTPS servers that do not use Transmission Control Protocol (TCP) for transmitting or receiving data. In the system a communication between the Non-Traditional HTTP client and the Non-Traditional server through the network using User Space Transport Protocol (UsTP) is established with a bandwidth greater than a bandwidth that is achieved using TCP.

In one embodiment, the plurality of Non-Traditional HTTP clients are configured to operate as a plurality of Traditional HTTP servers, the plurality of Traditional HTTP servers being configured to operate as HTTP or HTTPS servers that use Transmission Control Protocol (TCP) for transmitting and receiving data to and from one or more Traditional HTTP clients. The one or more Traditional HTTP clients being configured to operate as one or more HTTP or HTTPS clients that use Transmission Control Protocol (TCP) for transmitting and receiving data.

In one embodiment, the system further includes a load balancer configured to communicate with the one or more Traditional HTTP clients and the plurality of Non-Traditional HTTP clients. The load balancer is configured to split a communication from the one or more Traditional HTTP clients between the plurality of Non-Traditional HTTP clients that are configured to operate as a plurality of Traditional HTTP servers.

Another aspect of the present invention is to provide a computer-implemented method of transmitting data over a network, the method being implemented in a computer system comprising one or more computer processor units configured to execute one or more computer program modules. The method includes receiving, by a Non-Traditional HTTP server implemented on the computer system, a request from a Non-Traditional HTTP client through a network, the Non-Traditional HTTP server being configured to operate as a HTTP or HTTPS server that does not use Transmission Control Protocol (TCP) for transmitting or receiving data, the Non-Traditional HTTP client being configured to operate as a HTTP or HTTPS client that does not use Transmission Control Protocol (TCP) for transmitting or receiving data, the Non-Traditional HTTP server and the Non-Traditional HTTP client communicating through the network using User Space Transport Protocol (UsTP). The method further includes determining by the Non-Traditional HTTP server whether the request is valid. If the request is determined to be invalid, the method proceeds by sending, by the Non-Traditional HTTP server, an error message to the Non-Traditional HTTP client through the network over User Space Transport Protocol (UsTP). If the request is determined to be valid, the method proceeds by sending by the Non-Traditional HTTP server, requested data to the Non-Traditional HTTP client through the network over User Space Transport Protocol (UsTP).

A further aspect of the present invention is to provide a computer-implemented method of pre-allocating a data file using an HTTP request, the method being implemented in a computer system comprising one or more computer processor units configured to execute one or more computer program modules. The method includes sending, by an HTTP client, a request to an HTTP server to create or append an empty file, the request including a Content-Length header that identifies a size of the empty file.

Another aspect of the present invention is to provide a computer-implemented method of requesting available space using an HTTP request, the method being implemented in a computer system comprising one or more computer processor units configured to execute one or more computer program modules. The method includes sending, by an HTTP client, a request to an HTTP server to request an amount of total storage space on the storage device or an amount of free storage space available on the storage device associated with the server, or both, the request including a location of the storage device.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 depicts a conventional diagram of a Traditional HTTP client in communication with a Traditional HTTP Server;

FIG. 2 depicts a conventional diagram of a UsTP client in communication with a UsTP server;

FIG. 3 depicts a flow chart of a conventional communication method between a Traditional HTTP client and a Traditional HTTP server;

FIG. 4 shows a diagram of a Non-Traditional HTTP client in communication with a Non-Traditional HTTP server, according to an embodiment of the present invention;

FIG. 5A shows a diagram of a Traditional HTTP client that communicates with a non-Traditional HTTP server via Traditional HTTP Server (which also operates as a Non-traditional HTTP client), according to an embodiment of the present invention;

FIG. 5B shows a diagram of a Traditional HTTP client that communicates with a Traditional HTTP server, according to another embodiment of the present invention;

FIG. 6 depicts a flow chart of a communication method between a Traditional HTTP client and a Non-Traditional HTTP server, according to an embodiment of the present invention;

FIG. 7 depicts a conventional load balanced configuration in which one or more Traditional HTTP clients are in communication with one or more Traditional HTTP servers via a network and through a Load Balancer; and

FIGS. 8A, 8B and 8C depict various configurations of one or more Traditional HTTP clients in communication with one or more Non-Traditional HTTP servers, according to various embodiments of the present invention.

### DETAILED DESCRIPTION OF EMBODIMENTS OF THE INVENTION

There are alternatives to TCP and UDP transport protocols. However, these transport protocols are usually not common to an operating system and require additional software to utilize their capabilities. These alternative protocols are derived from the TCP transport protocol, UDP transport protocol, raw socket communication or a combination of these protocols. These protocols are transport protocols which function on top of the operating system socket interface. These transport protocols are referred to herein as user-space transport protocols (UsTP). Examples of user-space transport protocols (UsTP) are UDP-based Data Transfer Protocol (UDT), the Aspera® FASP™ protocol, and the Low Extra Delay Background Transport (LEDBAT).

The UDP-based Data Transfer Protocol (UDT) is implemented by using the operating system provided UDP transport protocol but further provides congestion control and reliability control mechanisms. For example, in a UDT client and a UDT server which communicate over a 100 Megabits (Mb) network, although the maximum theoretical throughput is about 12.5 MB/s, when adding 300 ms of latency to this network and when performing a data transfer for 10 GB worth of data, an approximate average throughput of greater than 10.0 MB/s can be achieved. This is because UDT is designed to transfer bulk data over LFN networks. Unlike TCP, UDT is a protocol that uses the UDP protocol. The UDP protocol includes an algorithm for error recovery that is designed to work on these types of networks where high latency and packet loss exist. A detailed description of the UDT protocol can be found for example in “Breaking the Data Transfer Bottleneck, UDT: A high Performance Data Transport Protocol,” by Yunhong Gu, published by the National Center for Data Mining, University of Illinois at Chicago, on Oct. 10, 2005 and updated on Aug. 8, 2009, the entire content of which is incorporated herein by reference.

Another example of a UsTP is the Aspera® FASP™ protocol. Aspera® FASP™ protocol utilizes several transport protocols such as UDP and TCP and communications protocols such as Secure Shell (SSH). The FASP™ protocol functions at the application level, and allows for reliable and secure data transfer. For example, in an Aspera® Enterprise Client and an Aspera® Enterprise Server which communicate over a 100 Megabits (Mb) network, although the maximum theoretical throughput would be 12.5 Megabytes per second (MB/s), when adding 300 ms of latency to this network and when performing a data transfer for 10 GB worth of data, an approximate average throughput greater than 10.0 MB/s can be achieved. This is because Aspera® FASP™ transfer is also designed to transfer bulk data over LFN networks. The FASP protocol includes an algorithm for error recovery that is designed to work on these types of networks where high latency and packet loss exist. A detailed description of the FASP protocol can be found for example in U.S. Pat. No. 8,085,781 entitled “Bulk Data Transfer,” to Munson et al., issued on Dec. 27, 2011, the entire content of which is incorporated herein by reference.

Another UsTP protocol is the Low Extra Delay Background Transport (LEDBAT) which is defined in RFC 6817. LEDBAT is an experimental delay-based congestion control algorithm that seeks to utilize the available bandwidth on an end-to-end path while limiting the consequent increase in queueing delay on that path. LEDBAT uses changes in one-way delay measurements to limit congestion that the flow itself induces in the network. LEDBAT is designed for use by background bulk-transfer applications to be no more aggressive than standard TCP congestion control (as specified in RFC 5681) and to yield in the presence of competing flows, thus limiting interference with the network performance of competing flows.

A firewall is a software-based or hardware-based network security system that controls incoming and outgoing network traffic by analyzing data packets sent through transport protocols to determine whether the packets should be allowed or not allowed through based on a rule set. For example, a possible firewall configuration may limit network access to only to Domain Name System (DNS), HTTP, and HTTPS. On most networks, HTTP and HTTPS are commonly used communication protocols that are typically always allowed. On the other hand, a protocol such as FTP may be blocked by a firewall due to security concerns.

Although user-space transport protocols UsTP can offer an advantage over TCP in the case of a LFN, UsTP protocols are commonly not included with the operating systems. As a result, additional software is required in order to use UsTP protocols. In addition, UsTP are not commonly used on a network due to the ports and protocols required. UsTP are commonly blocked because they are unofficial per Internet Assigned Numbers Authority (IANA) and are therefore unknown to most networks.

UDT resides at the transport layer (i.e., layer 4) of the OSI model. Users can simply download the software and start to use it (plug and play). UDT's Application Program Interface (API) is similar to BSD sockets. Since UDT is a user-space transport protocol UsTP, it does not provide a communication protocol such as HTTP or HTTPS. Therefore, in order to utilize this technology as a communication protocol, one would need to write a client and server with a communication protocol. In addition, the UDP port number is undefined, and therefore implementation specific, and would have issues running on a network with a firewall that does not have this specific UDP port open. Finally, to utilize this API, a computer system on a network would need to have a UDT server installed. Furthermore, every computer system that functions as a UDT client that intends to access a UDT sever would need additional software installed to utilize this technology. Therefore, this creates a burden to the network administrator because, not only the UDT must be installed on every client in a plurality of clients, which could be a large number of clients, but also a rule added to the firewall to allow the UDT to be utilized in each and every client.

For a client to use the Aspera® FASP™ protocol, it would require a computer system with a server that implements also Aspera® FASP™ such as an Aspera® Enterprise Server. The server requires unofficial ports and utilization of TCP and UDP transport protocols on the network to function. In addition, any client that would like to communicate with such server is also required to implement the FASP™ protocol. In other words, any client that accesses the Aspera® Enterprise Server would need additional software such as the Aspera® Enterprise Client which is a thick client GUI or Aspera® Connect which is a web browser plugin. This software is not part of the computer operating system. To take advantage of the FASP™ protocol additional software is required. Therefore, this also creates a burden to the network administrator because, not only the UsTP (Aspera® FASP™) must be installed on every client in a plurality of clients, which could be a large number of clients, but also a rule added to the firewall to allow the UsTP to be utilized in each and every client.

Another technique that improves data transfer over a LFN is the use of data compression. Data compression involves encoding information using fewer bits than the original data. Data compression is useful because it reduces the amount of data that is needed to be transmitted over a network. There are two types of compression techniques: lossless and lossy.

Some examples of lossless compression techniques used to compress data are Lempel-Ziv (LZ), Finite State Entropy (FSE), LZF, Roshal ARchive (RAR), ZIP, and many others. These compression techniques take an original data buffer and perform an encoding process to convert this buffer into a compressed buffer. The size of the compressed buffer is based on how well the compressed encoding technique is able to compress the data. When decompressing the data using any of these techniques, the original data buffer can be reconstructed.

Some examples of lossy encoding techniques used to compress data can vary based upon the content being compressed. For example, an uncompressed WAV audio file can be compressed using MP3 compression. Although the audio contained within the MP3 is similar to the original WAV, the compressed audio MP3 file does not offer the same audio quality as the original WAV audio file. For example, a GeoTIFF image can be compressed using JPEG compression to reduce the size of the image data being transmitted. Although the compressed image may look similar to the original image, if one were to compare every pixel within the original image and the compressed image, it would appear that some pixels in the compressed image and the original image would be different. In addition, a loss of metadata of the original image (such as geospatial coordinates) can also occur thus leading to a JPEG image with reduced or incomplete metadata.

A Traditional or Non-Traditional HTTP client and server support lossless compression as specified in the HTTP protocol. For example, a client using a request method can optionally include the Accept-Encoding header to specify a lossless compression method. The Traditional or Non-Traditional HTTP server, if supporting the specified lossless compression, can compress the data and include Content-Encoding with the compressed data buffer. One requirement of the HTTP protocol is that the server must supply either the Content-Length to identify the total size of the buffer being transmitted or supply the Transfer-Encoding header where one can specify that the data is being transferred in chunks. This depends how the compressed data is transferred.

When the Traditional or Non-Traditional HTTP server sends compressed data, the server also supplies a Content-Length and Content-Encoding HTTP header with the data informing the client that the server is sending compressed data. The Content-Encoding header describes the method used (e.g., Zip File) for compression, and the Content-Length provides the size of the compressed data sent. For example, 100 KB is compressed to 32 KB and thus 32 KB is what needs to be described in the Content-Length. For a small buffer such as 100 KB, to perform this compression in memory is trivial to a 32 KB compressed archive. However to perform a compression on a 10 GB file this can become impossible because resource limitations such as not enough physical memory. Additionally, it would take a long time. If the Zip method runs at 10 MB/s, when you process a 10 GB file, it would take so long that the average HTTP client would timeout which is typically 2 minutes. Therefore, this option is only reserved for small data buffers.

To define what Content-Encoding methods are supported by a server, a Traditional or Non-Traditional HTTP client can send an OPTIONS request to the server and the server would provide a comma delimited list of possible lossless compression methods supported by the server.

In an alternative method, a Traditional or Non-Traditional HTTP server can send compressed data using the Transfer-Encoding header in conjunction with Content-Encoding header, which specifies that the compressed data is sent in chunks. The data transfer by the server has an unspecified number of chunks. Each chunk starts with the number of octets of data it embeds expressed as a hexadecimal number in ASCII. Optionally, there could be a chunk-extension which is a name value pair that is delimited by a semi-colon. This is followed by a carriage return, followed by line feed (CRLF). The chunk ends with the compressed data followed by a CRLF. This process repeats for each chunk of data that is sent. Once all data has been transferred there is a terminating chunk which contains a zero followed by a CRLF. After which there is a final CRLF and the transfer is complete. In using this method, the Traditional or Non-Traditional HTTP client does not have enough information to determine the percentage of the data that has been transferred. Although the size of each compressed chunk is known, the uncompressed size of the corresponding chunk is not known.

A Traditional or Non-Traditional HTTP client and server can support lossy compression through the use of a Representational State Transfer (REST) API, Simple Object Access Protocol (SOAP) API or through extended non-standard headers that are not specified within the RFC-2616 specification. REST and SOAP are protocols that have a dependency on the HTTP or HTTPS protocol to further define syntax for data exchange using the Traditional or Non-Traditional HTTP or HTTPS protocol. Although REST, SOAP, or non-standard headers do not provide any form of compression, they allow for more input to be provided with a request which allows for more intelligent data access to occur that enable lossy compression.

Various web services exist that can be implemented in a server-client platform. These web services include, for example, the OGC:WAMI (Open Geospatial Consortium Wide Area Motion Imagery) specification. Some web services are maintained by a standards committee to support interoperability of data exchange to a plurality of applications. One such standards committee is the Open Geospatial Consortium (OGC) that has defined standard Web Services such as Web Mapping Service (WMS), which is a REST API. In the WMS version 1.1.1 specification, there are three supported requests: GetCapabilities, GetMap and GetFeatureInfo. In the case of a GetMap request, a REST request is made to produce a JPEG image in a specified coordinate system of a specific pixel dimension and file format at a specified bounding box. Therefore, this Web Service may need to convert a plurality of remote sensing data such as a GeoTIFF or other image format to a JPEG image and transfer the JPEG image to a client. The compression achieved can be massive as it depends on the amount of data needed to be processed on the server to produce the resulting product. This is an example of lossy compression.

The HTTP protocol additionally supports the concept of partial file data exchange. This means that an HTTP client can request a part of a file or update a portion of a file based on the protocol. An example of partial file data exchange can be seen in the HTTP protocol by using the GET or POST range request. This is defined in section 14.35.2 of RFC 2616 which indicates that a client makes Range Retrieval Requests when it makes a partial content request. This means that an HTTP client does not need to transmit the whole file but rather only a portion of the file which is specified by including a Range header within the request. For example, if a 10 GB file is hosted by an HTTP server (for example), an HTTP client can make or send a GET or POST request with a Range header of 0-99 for the 10 GB file. In response to the request, the server can transmit, for example, 100 bytes of the 10 GB file to the HTTP client. This allows a user to specify the location within a data file where the desired data is located. For example, in a 10 GB file, a user or client may be able to request a portion of the file (for example 21 MB) that is located at a certain offset. To do so, a client sends a request to the server where the 10 GB file is located by providing a Range along with a GET or POST request.

Another example of partial file data exchange can be seen in the HTTP protocol in a PATCH request. This method is defined within RFC 5789. This method allows for a partial file update. The existing HTTP PUT method which is defined within the RFC 2616 only allows a complete replacement of a file, HTTP POST is another possible way to implement a partial file update. However, HTTP POST does not provide broad interoperability because there is no standard which formally defined within RFC 2616. The HTTP PATCH method allows for one to specify a file and an offset within that file to make a modification.

A feature that does not exist within the HTTP specifications is the concept of pre-allocating a file on disk. When using the HTTP PATCH method it assumes a file already exists, and can only be valid if the PATCH request exists within range specified. The operating system offers numerous methods of pre-allocation which allows a computer system to create a file of a specified size.

The HTTP protocol allows for standard file I/O operations. For example, the HTTP GET request can be handed by the server as a read operation for a file. This is extended within HTTP IETF RFC 4918 implementation of WebDAV which defines method for actions such as deleting a file or a directory listing, Finally, the HTTP PATCH method allows for a partial file update. Therefore, an HTTP server can be used as a file system. However, there are certain functions that do not exist within the WEBDAV standard such as pre-allocating a file, and reporting the available space on a storage device.

Pre-allocating a file on a storage device (e.g., disk) is defined herein as a function that creates or appends to a file of a given size. For example, an identifier for the file such as a directory and filename, or uniform resource identifier (URI) is specified when a function to pre-allocate the file on a disk or storage device is used. In addition, a size of the file is also specified. The result is that this function prepares the file to take these resource prior to any useful data is written. In general, a file is defined as a resource for storing information that is available to a computer system. Data is defined as the information contained within the file.

There are many methods of creating a pre-allocated file. One method is by using the standard library functions provided with the C programming language. Traditionally, these functions exist within the stdio.h. Another method is by using operating system specific functions such as using the Microsoft® Windows® WinAPI.

To pre-allocate a file using the standard library functions provided with the C programming language, the fopen( ) function is performed on a file. The fwrite( ) function can then be used to write 1 MB of data, for example, to the file. The fwrite( ) function can be repeated until the file reaches the desired size, such as 1 GB. Finally, the fclose( ) function is used to complete the file creation process.

Other standard C programming functions can also be used to pre-allocate to an existing file by appending bytes to the end of the file. The fopen( ) function is first applied on the file to open the file. Then, the ftell( ) function can be used to resolve the file size. In addition, fseek( ) function can be used to move the file pointer to the end of the file based on the result from ftell( ) Finally, fwrite( ) function can be used to write data to the file until it reaches the desired size.

Another method to create a pre-allocated file on a disk or storage device would be to use an operating system specific function. For example, on the WINDOWS platform, there are various method of creating a pre-allocated file such as using the SetFileValidData( ) function. The SetFileValidData function avoids filling data with zeros. Rather, SetFileValidData( ) is a method to avoid filling data to a file, and the result is that a file can be pre-allocated almost instantly, assuming that appropriate permissions are provided in the process. The resulting file will contain unclean data.

Another method that does not exist within the HTTP protocol is one that provides information regarding the amount of available free space. Free space is defined as the amount of bytes available on a given storage device or storage devices that are presented by the HTTP protocol. For example, using the Microsoft® WINDOWS® WinAPI, there is a function called GetDiskFreeSpace( ) When applied to a storage device, this function can report back the amount of available space on that device. However, there is no similar method within the HTTP protocol to perform this type of action.

When transmitting data over a network, it may be desired to encrypt the data so that only authorized parties are able to read it. An example of encryption method is seen in the HTTP protocol whereby it allows for HTTPS which uses SSL/TLS to provide encryption. There is no mandatory function for a UsTP protocol to provide encryption. However, encryption can be optionally implemented by wrapping data using an encryption method. For example, the Aspera® FASP™ protocol provides inline encryption. However UDT does not provide any method of encryption.

An example of a method to encrypt data in the case of UDT would be to use Advanced Encryption Standard (AES) which is defined within the Federal Information Processing Standards Publication 197. AES provides a method to encode data such that only an authorized party can decode. Therefore, before transmitting data using UsTP, AES can be used as an example to encode and decode data. Another related technology is the NFS protocol whereby NFS v3 is identified in RFC 1813. This technology provides a stateless network file system which is a well-known technology for performing standard file I/O operations over a network.

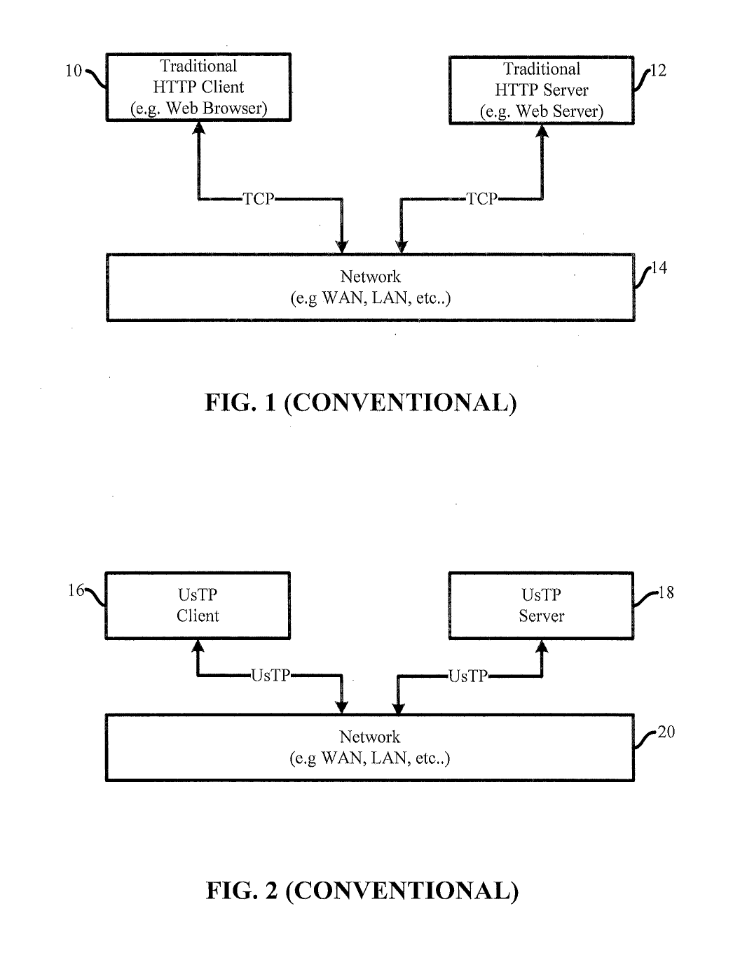

FIG. 1 depicts a conventional diagram of a Traditional HTTP client in communication with a Traditional HTTP Server. The Traditional HTTP Client 10 makes an HTTP request to a Traditional HTTP server 12. The HTTP server sends a response back to the Traditional HTTP client 10. The Traditional HTTP client 10 makes a request using the TCP/IP transport protocol over a network 14 to the Traditional HTTP server 12. The Traditional HTTP server 12 responds using the TCP/IP transport protocol over the network 14 to the Traditional HTTP client 10 with the response for the given request. There are many applications that can function as an HTTP client. A popular application is a web browser which is an example of a Traditional HTTP client, A web server is an example of a Traditional HTTP server.

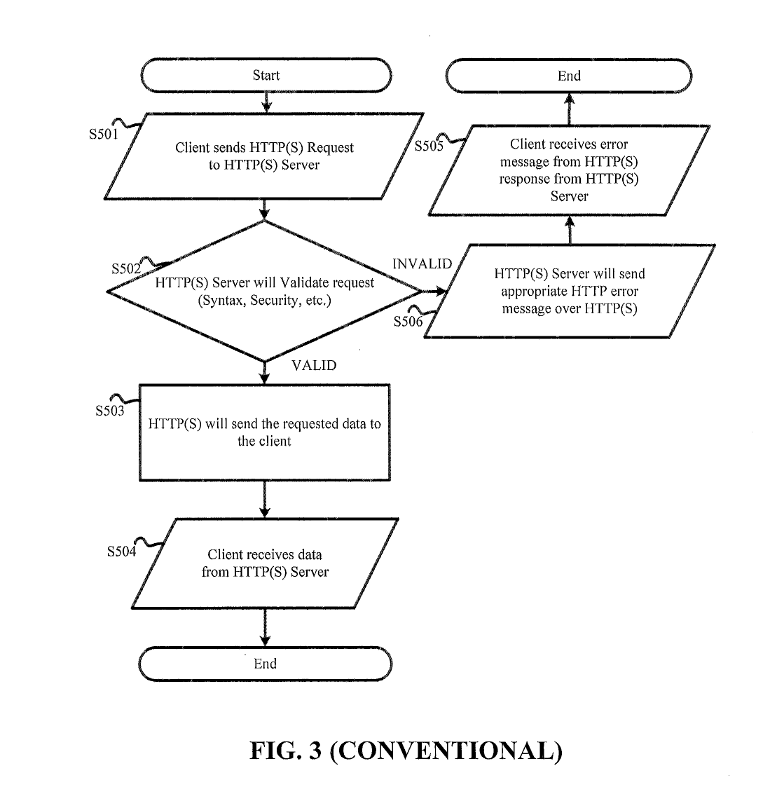

FIG. 2 depicts a conventional diagram of a UsTP client in communication with a UsTP server. UsTP client 16 sends a request to UsTP server 18. UsTP server 18 sends a response back to the UsTP client 16. UsTP client 16 and UsTP server 18 are non-standard software commonly not included with the operating system, and are built upon the standard transport protocols such as TCP and UDP. UsTP client 16 and UsTP server 18 may encompass communications protocols such as Secure Shell (SSH). Because UsTP client 16 and UsTP server 18 are non-standard to the operating system, the client 16 and server 18 both require software to be installed in order to be utilized. In addition, both client 16 and server 18 require specific ports and transport protocols to be accessible. If server 18 is a UDT server that operates on UDP 8000, UDP must be allowed in the network connection between client 16 and server 18 due to network security devices such as a firewall blocking this traffic, Therefore, if one were to have an enterprise with a large number of computer systems that have UDT clients, they would all need to have UDP port 8000 open. Therefore, UsTP such as UDT is not practical in these types of environments. In addition, UsTP does not contain a well-known communication protocol, therefore if one were to perform an action, such as ask for a byte-range of a file, this would be implementation specific using the UsTP.

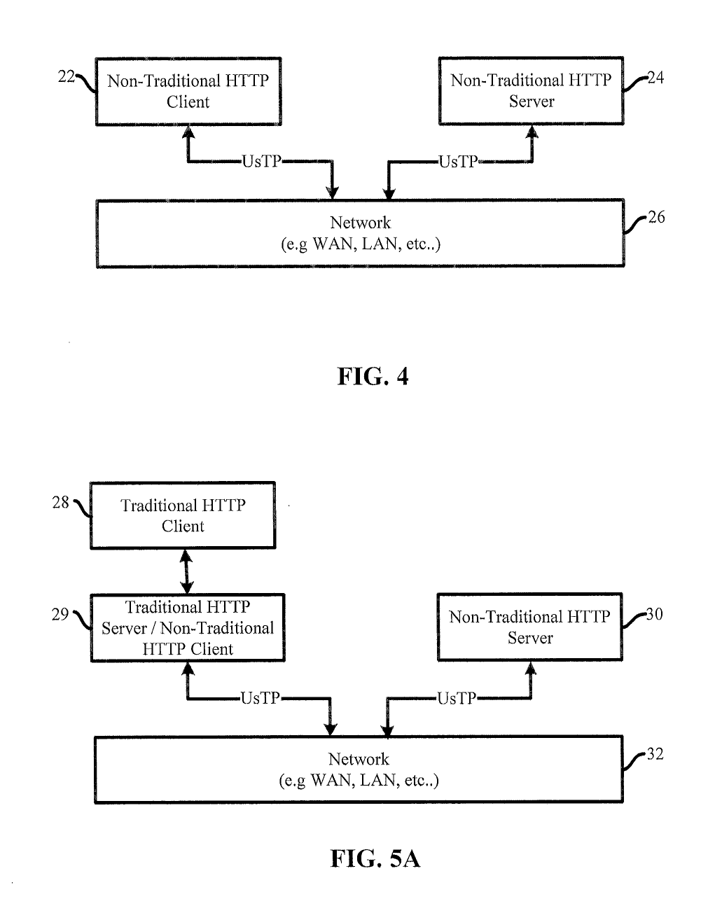

FIG. 3 depicts a flow chart of a conventional communication method between a Traditional HTTP client and a Traditional HTTP server. The method includes sending by a Traditional HTTP client a HTTP request to a Traditional HTTP server, at 5501. The method further includes receiving by the Traditional HTTP server the request and determining by the Traditional HTTP server whether the request is valid in terms of syntax and security, at 5502, If the request is invalid, sending by the Traditional HTTP server an appropriate HTTP error message, at 5506. The method further includes, receiving by the Traditional client the error message, at 5505. Otherwise, if the request is valid, sending by the Traditional HTTP server the requested data to the Traditional HTTP client, at 5503. The Traditional HTTP client then receives the requested data from the Traditional HTTP server, at 5504.

When a Traditional HTTP client requests a data file to a Traditional HTTP server may return data file in a compressed format to decrease the size of file for transmission through the network. In some circumstances, when the file is relatively large (for example, 1 GB or greater) the file may be divided into chunks or portions and then the chunks or portions compressed by the HTTP server and transmitted in a form of a response to the HTTP client through the network. An Encoding header and a Content-Encoding are included by the Traditional HTTP server in the response. For example, the data can be sent in N number of chunks or portions. N is only known to the server and not known to the client. The only information that the client is receiving (i.e., “knows”) is a size of the compressed data as a whole followed by the compressed data in a desired format. The client may receive each data portion with a variable compression level. For example, if a server compresses data to a sequence of zeros for 1 MB of data, the data may be highly compressible to 10 bytes. Whereas if one were to have JPEG2000 imagery data that has already been compressed, it actually may inflate the data to 1.2 MB in size. Therefore, the client does not have enough information to determine a ratio of received data divided by total data, because total data is undefined in the response by the server. This method does not allow the client that receives the chunked data to determine the size of the source data using the encoding header as the encoding header does not contain information (metadata) pertaining to the compression ratio.

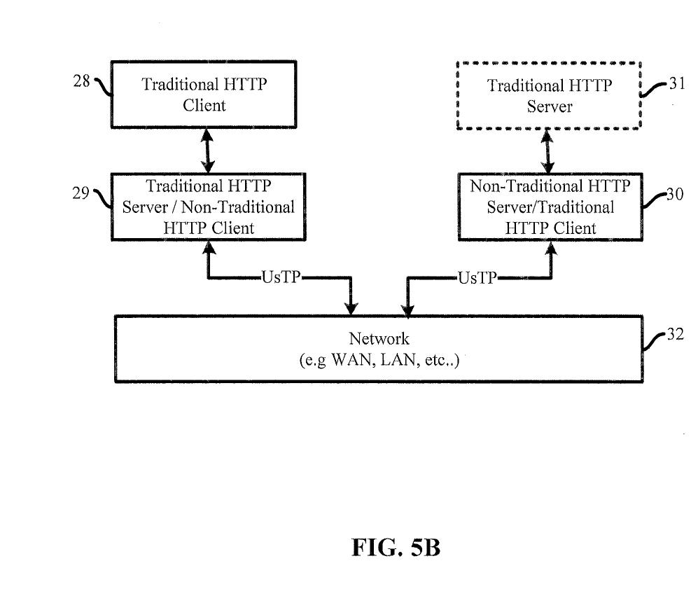

FIG. 4 shows a diagram of a Non-Traditional HTTP client 22 in communication with a Non-Traditional HTTP server 24, according to an embodiment of the present invention. Non-Traditional HTTP client 22 communicates with Non-Traditional HTTP server 24 via network (e.g., WAN, LAN, Internet, etc.) 26. Client 22 which follows the HTTP protocol can send data and receive data from server 24 which also follows the HTTP protocol. In addition, both client 22 and server 24 allow for UsTP transport protocol to be utilized. As stated in the above paragraphs, HTTP is a communication protocol that has a defined syntax that allows exchange of complex data. UsTP is a transport protocol that simply transports data “as is.” In this case, HTTP client 22 uses transport protocol UsTP to communicate through network 26 with Non-Traditional server 24 which also uses UsTP as a transport protocol. In one embodiment, the HTTP client 22 can access, for example, any Web Service such as a Representational State Transfer (REST) Web service that is provided by server 24. An example of a REST Web Service implemented on server 24 is the OGC WMS protocol. By using the Non-Traditional HTTP client 22 and Non-Traditional HTTP server 24 over UsTP transport protocol as a transport protocol, a communication between client 22 and server 24 can be established over high latency network such as a LFN while achieving a relatively high bandwidth, i.e., achieving a greater bandwidth than a bandwidth that can be achieved using standard TCP. For example, if only 10% of the theoretical bandwidth is achieved using TCP, by using UsTP, a bandwidth greater than 10% of the theoretical bandwidth can be achieved (e.g., 50% of the theoretical bandwidth). The network described in various embodiments (for example network 26) can be any type of network including a Wide Area Network (WAN) or Local Area Network (LAN), the Internet or World Wide Web (WWW), etc. The network 26 can be a wired network or a wireless network.

FIG. SA shows a diagram of a Traditional HTTP client 28 that communicates with a non-Traditional HTTP server 30 via Traditional HTTP Server (which also functions as Non-traditional HTTP client) 29, according to an embodiment of the present invention. First, Traditional HTTP client 28 communicates with Traditional HTTP server 29 which also operates as Non-Traditional HTTP client. In one embodiment, the Traditional HTTP server and Non-Traditional HTTP client 29 can be implemented on the same machine or device or on the same piece of software. The Non-Traditional HTTP client 29 communicates with Non-Traditional HTTP server 30 using transport protocol UsTP, In one embodiment, a request made by the Traditional HTTP client 28 is first sent to Traditional HTTP server 29. The request is translated from the Traditional HTTP server to the Non-Traditional HTTP client in 29. The Non-Traditional HTTP client 29 sends the request using transport protocol UsTP over LFN network 32 to Non-Traditional HTTP server 30. In response to the request, the Non-Traditional HTTP server 30 can return a resource from a file or Web Service back to Non-Traditional HTTP client 29 using transport protocol UsTP. The Non-traditional HTTP client 29 forwards or translates the resource to Traditional HTTP server 29 which transmits the resource to the Traditional HTTP client 28. For example, by using a translation mechanism from Traditional HTTP data into a Non-Traditional HTTP data for transport through the UsTP transport protocol, it is possible to send the data through LFN that has a relatively high latency while maintaining a relatively high bandwidth, i.e., a greater bandwidth than a bandwidth that can be achieved using standard TCP. For example, if only 10% of the theoretical bandwidth is achieved using TCP, by using UsTP, a bandwidth greater than 10% of the theoretical bandwidth can be achieved (e.g., 50% of the theoretical bandwidth). Furthermore, this configuration avoids installing specialized software on a network because all clients can take advantage of through the use of this system because all clients use Traditional HTTP. The translation from Traditional HTTP to Non-Traditional HTTP for transport through a network using UsTP is implemented at 29 downstream of any Traditional HTTP client.

As it can be appreciated, the Traditional HTTP client 28 can represent one, two or more Traditional HTTP clients 28. Each of the one or more Traditional HTTP clients 28 communicates with one traditional HTTP server (also Non-Traditional HTTP client) 29. The Non-Traditional HTTP client 29 may then communicate through network (e.g., LFN) 32 with one or more Non-Traditional HTTP servers 30. For example, one of a plurality of Traditional HTTP clients 28 may send a request to a specific one of a plurality of Non-Traditional HTTP servers 30. The specific one of the plurality of Non-Traditional HTTP servers 30 can then respond by transmitting back a requested resource (e.g., a file or a portion of file containing requested data) to the client in the plurality of Traditional HTTP clients 28 that sent the request.

In one embodiment, a request or data can be translated from the Traditional HTTP server to the Non-Traditional HTTP client and vice versa, at 29, seamlessly by translating the request or data from a TCP request/TCP data into a UsTP request/UsTP data (for example a UDT request/UDT data) or vice versa. For example, when the Non-Traditional HTTP client 29 receives data from the Non-Traditional HTTP server 30 through the UDT transport protocol, the Non-Traditional HTTP client 29 puts the data in a memory buffer using “UDT::recv(sockfd, recvBuffer . . . xbuffer_add(http->result . . . ”, as illustrated in the following portion of a code executed by Non-Traditional HTTP client 29.

```
while((bytesReceived = (UDT::recv(sockfd, recvBuffer, sizeof(recvBuffer), 0))) > 0) {
  xbuffer_add(http->result, (unsigned char *)recyBuffer, bytesReceived);
    if (callback) { // call the callback
      if (callback(&cb_data) < 0) {
        ret = −1;
        break;
      }
    }
  if(http->die != 0) break;
}
```

The Traditional HTTP server which also operates as the Non-Traditional HTTP client 29 reads the data in the memory buffer using “xread(buf, offset . . . )” and converts or translates the data into HTTP using “xudthttpd_fwrite . . . ” as illustrated in the following portion of a code executed by the Traditional HTTP server/Non-Traditional HTTP client 29.

```
while((n = xread(buf, offset, bufsz, xp)) == bufsz) {
  if(lzf) s = xudthttpd_fwrite_lzf(buf, bufsz, 1, cli);
  else if(fse) s = xudthttpd_fwrite_fse(buf, bufsz, 1, cli);
  else s = xudthttpd_fwrite(buf, bufsz, 1, cli);
  offset += n;
  if(s != n) {
  xlog(″Error: xudthttpd_fwrite() %d != xread() %d″, s, n);
  goto full_read_end;
      }
    }
```

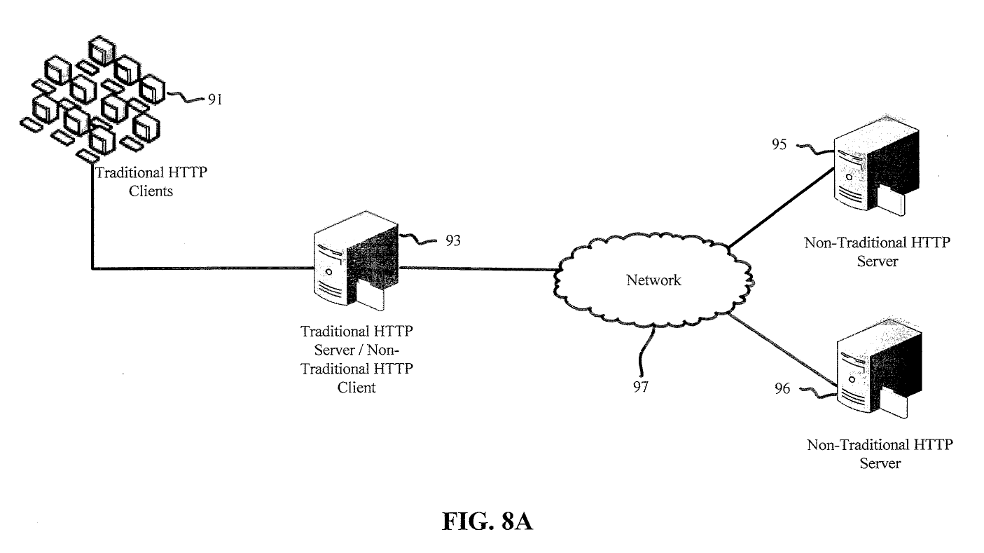

FIG. 6 depicts a flow chart of a communication method between a Traditional HTTP client and a Non-Traditional HTTP server, according to an embodiment of the present invention. The method includes sending by a Traditional HTTP client a request to a Traditional HTTP Server (also acting as a Non-Traditional HTTP server), at 5601. The method includes receiving by the Traditional HTTP server the request, and determining by the Traditional HTTP Server whether the request is valid in terms of syntax, and security, at 5602. If the request is invalid, sending by the Traditional HTTP server an appropriate HTTP error message, at 5606, and returning by Traditional HTTP server the response to the Traditional HTTP client, at S605. Otherwise, if the request is valid, translating by the Traditional HTTP server the same HTTP request to the Non-Traditional HTTP client, at 5603. The requested is translated from a Traditional HTTP request received by the Traditional HTTP Server into a Non-Traditional HTTP request. If the request is invalid, sending by the Traditional HTTP server an appropriate error message back to the Traditional HTTP client, using TCP, at 5606. The method includes receiving by the Traditional HTTP client the error message from the Traditional HTTP server, at S605. If the request is valid, sending by the Traditional HTTP server/Non-Traditional HTTP client the request to the Non-Traditional HTTP server over the UsTP transport protocol, at 5611. The method includes determining by the Non-Traditional HTTP server whether the request received by the Non-Traditional HTTP server from the Non-Traditional HTTP client is valid in terms of Syntax, security, etc., at 5604. If the request is invalid, sending by the Non-Traditional HTTP server an error message to the Non-Traditional HTTP client through a network (e.g. LFN) using UsTP transport protocol, at 5607. The error is translated by the Non-Traditional client to the Traditional HTTP server. The Traditional HTTP server that also operates as the Non-Traditional HTTP client then forwards the error message to the Traditional HTTP client, using TCP for example, at 5606. The traditional HTTP client receives the message, at S605. If, on the other hand, the request is determined to be valid by the Non-Traditional HTTP server, servicing the request by the Non-Traditional HTTP server and sending requested data (e.g., a file or a portion of a file, etc.) to the Non-Traditional HTTP client/Traditional HTTP server through the network (e.g., LFN) using the UsTP transport protocol, at S610. The Non-Traditional HTTP client/Traditional HTTP server receives the data from the Non-Traditional HTTP server over UsTP. The data is translated by the Non-Traditional HTTP client to the Traditional HTTP server. The Traditional HTTP server then sends the data to the Traditional HTTP client via TCP, at 5609. The Traditional HTTP client receives the data (i.e., the response for the request from the Non-Traditional HTTP server) from the Traditional HTTP server, at 5608.

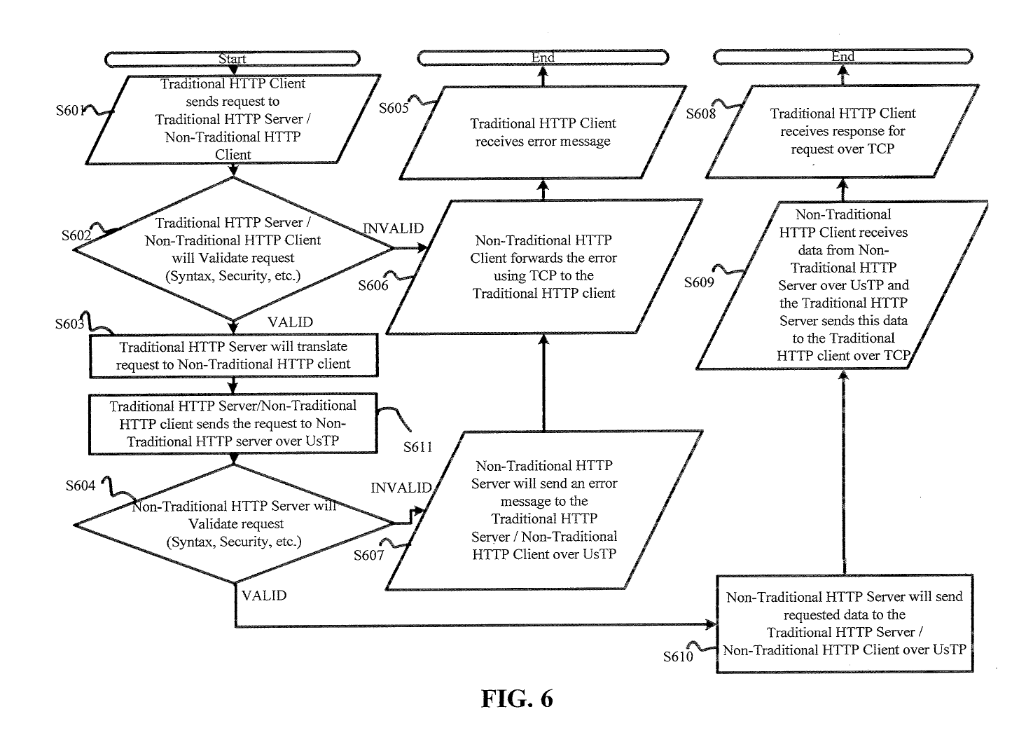

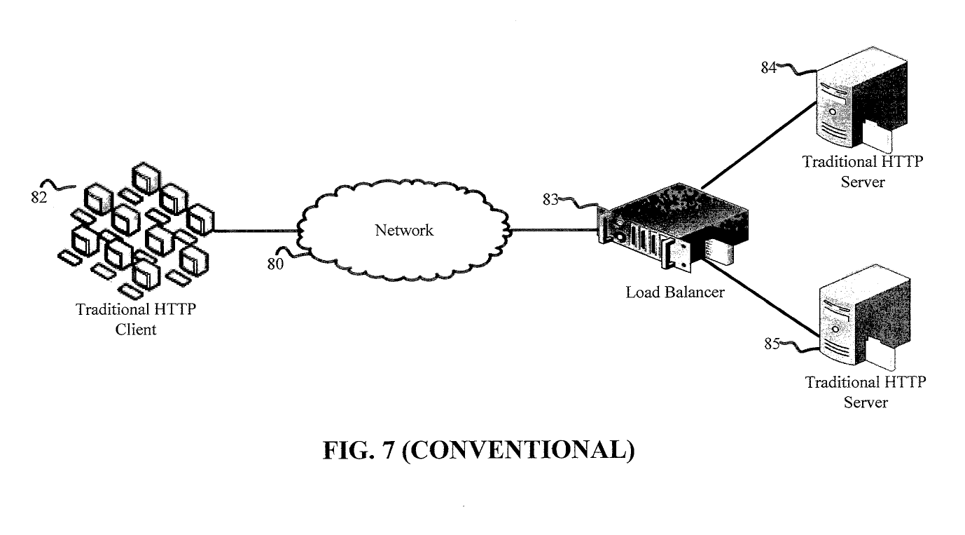

FIG. 5B shows a diagram of a Traditional HTTP client 28 that communicates with a Traditional HTTP server 31, according to another embodiment of the present invention. This configuration is similar in many aspects to the configuration shown in FIG. 5A. However, in this case, the Non-Traditional HTTP server 30 may or may not be configured to support a type of a web service such as a an OGC WMS. In some instances, a Traditional HTTP server 31 which can be configured to support OGC WMS may be connected to the Non-Traditional HTTP server 30. To allow communication between the Non-Traditional HTTP server 30 and the Traditional HTTP server 31, the Non-Traditional HTTP server can be configured to also operate as Traditional HTTP client 30 which in turn can communicate seamlessly using TCP with Traditional HTTP server 31. If the Non-Traditional HTTP Server 30 were to have an implementation of a Web Service, such as the OGC WMS protocol instead of UsTP protocol, it would be subject to a lossy compression. In addition, even if the Non-Traditional HTTP Server 30 may be operated as a Traditional HTTP Client 30 that is configured to forward a request to a Traditional HTTP Server 31 running a Web Service (e.g., OGC WMS), this configuration would also be subject to a lossy compression. For example, if the Traditional HTTP client 28 were to make a GetMap request of a JPEG image of a given geospatial dataset, the Traditional HTTP Server that functions as a Non-Traditional HTTP Client 29, as shown in FIG. 5B and FIG. 5A and as described above, may forward the GetMap request over the LFN network 32 using the UsTP protocol to optimize the performance of data transfer due to high latency and packet loss. The Non-Traditional HTTP server 30 can be an OGC WMS server or can be configured to also operate as a Traditional HTTP client 30. The Traditional HTTP client 30 in turn can send a request to the Traditional HTTP Server 31 that hosts the OGC WMS Web Service. The Traditional HTTP server 31 responds to the request from the Traditional HTTP client which exists within the Non-Traditional HTTP server 30. In response to the request, the requested data is sent by the Traditional HTTP server 31 to the Traditional HTTP client 30 over the TCP transport protocol.

As it can be appreciated, when implementing a web service such as, for example, OGC:WMS, there are two methods that can be used. A first method wherein the OGC:WMS can be written using a Non-Traditional HTTP server (e.g., Non-Traditional HTTP server 30), as depicted in FIG. 5A and a second method wherein the Non-Traditional HTTP server 30 is configured to also operate as a Traditional HTTP client that communicates with a Traditional HTTP server 31 within which the OGC: WMS application is implemented, as depicted in FIG. 5B.

Referring back to FIG. 5A, for example, in one embodiment, a Traditional HTTP client 28 can make a request using the request method of HEAD to the Non-Traditional HTTP Server 30. The Non-Traditional HTTP Server 30 may reply to the HEAD request from the Traditional HTTP client 28 if the file exists. If the file exists, the size of the file is identified within the Content-Length of the file. The Content-Length can be sent from the Non-Traditional HTTP server 30 to the Non-Traditional HTTP client that also operates as Traditional HTTP server 29. The Traditional HTTP server 29 then forwards the Content-Length information to the Traditional HTTP client 28. In this way, the Traditional HTTP client 28 may know, prior to receiving any data from the Non-Traditional HTTP server 30, the total size of the data including HTTP header information that the client may potentially receive. After sending the HEAD request and receiving an appropriate response to the HEAD request, the Traditional HTTP client 28 can then send a GET request to the Non-Traditional HTTP server 30. The GET request may contain a RANGE header to request for a portion of a file or the whole file containing the requested data. In response to the GET request, the non-Traditional HTTP server 30 can send N integer number portions or chunks of the file to the Non-Traditional HTTP client 29 through network (e.g. LFN) 32. The Non-Traditional HTTP client 29 which also operates as the traditional HTTP server sends the N integer portions or chunks of the file to the Traditional HTTP client 28. In this case, the integer number N is known by the Traditional HTTP client 28 because the Content-Length information is provided or defined within the Content-Length information received by the Traditional HTTP client in response to the HEAD request.

In one embodiment, when a data chunk or portion of a file is sent by the Non-Traditional HTTP server 30, two integer values prefixing the data are sent with the data chunk. These integer values are compressed data size C and uncompressed data size U. For example, if a server were to use an unsigned integer which is a 32-bit value to provide the compressed data size C and the uncompressed data size U, the C and U values are sent first as 8 bytes. The order of C and U does not matter. In this way, the client 28 is informed that the data chunk that is sent is of size C. The uncompressed data can optionally be encrypted by the Non-Traditional HTTP server 30 using a method such as AES before being compressed and sent through network 32 using UsTP transport protocol. Using encryption such as AES encryption provides for secure data transmission over the network using UsTP even when the UsTP transport protocol does not support encryption natively. In addition, Non-Traditional HTTP client/Traditional HTTP server 29 is configured so that when it receives the data chunk, the Non-Traditional HTTP client/Traditional HTTP server 29 can decompress the data chink (with size U). The uncompressed data chunk is sent by the Traditional HTTP server 29 to the Traditional HTTP client 28. In this way, the Traditional HTTP client 28 can get a valid estimate time for the compressed data transmission over the HTTP protocol.

In another embodiment, Traditional HTTP client 28 can send a PATCH request to the Non-Traditional HTTP server 30. The PATCH request may contain an OFFSET header to identify an offset within a file to modify the Content-Length that describes the size of the data being sent. The PATCH request can modify a portion of a file or the whole file. Optionally, when modifying the whole file using the PATCH request, a PUT request may be used instead. When sending PATCH or PUT request, the Non-Traditional HTTP client 29 can send N number of chunks to the Non-Traditional HTTP server 30. In this case integer number N is defined because the Content-Length is defined. In addition, the Non-Traditional HTTP client 29 can also send 2 integer values that prefix the data being sent. These integer values are compressed data size C and uncompressed data size U. The U and C values are followed by the compressed data chunk. For example, if a client were to use an unsigned integer which is a 32-bit value to provide the compressed data size C and the uncompressed data size U, the C and U values are sent first as 8 bytes. The order of C and U does not matter. In this way, the server is informed that the data chunk that is sent is of size C. The uncompressed data can optionally be encrypted using a method such as, for example, AES before being compressed. In addition, the Non-Traditional HTTP server 30 is configured so that when server 30 receives the compressed buffer, the server 30 can use U amount of memory to decode (i.e., decompress) the compressed data. The Traditional HTTP client can optionally receive an acknowledgement from the server 30 by receiving a 200 status reply.

For example, the Traditional HTTP client 28 uploads a series of 1 MB chunks of data to the Traditional HTTP server 29. The Traditional HTTP server 29 can compress the chunk of data using any desired compression method. For example, the server 29 may compress the data by a 2:1 ratio to provide a compressed chunk of data of 500 KB. The traditional HTTP server 29 which function as a non-traditional HTTP client transmits this compressed chunk of data as following [1 MB][500 KB][COMPRESSED DATA] to the Non-Traditional HTTP server 30. The Non-Traditional HTTP server 30 can then decode or decompress the chunk of data because the Content-Encoding header contain information how to decode the chunk of data (e.g. FSE). This may repeat N times for each of the N chunks (for example N is equal to 1000), until all data (e.g., about 1 GB) is sent to the server 30.

In addition to compression, each chunk of data send may also be encrypted, for example, using AES 256. The Traditional HTTP client 28 uploads a series of 1 MB chunks of data to the Traditional HTTP server 29. The Traditional HTTP server 29 can encrypt the 1 MB of data to 1.2 MB, which is now the new uncompressed data size. The Traditional HTTP server 29 can further compress this chunk (compress 1.2 MB), for example by a 2:1 ratio to obtain a compressed chunk of about 600 KB. The traditional HTTP server 29 which operates as a non-traditional HTTP client can then transmit this compressed encrypted chunk as the following [1.2 MB][600 KB][COMPRESSED and ENCRYPTED DATA] to the Non-Traditional HTTP server 30. The Non-Traditional HTTP server 30 can then decode this because of the Content-Encoding header contains information how to decode this chunk of data (e.g. FSE/AES256).

The POST request method allows the HTTP protocol to in an implementation specific way implement a GET or PATCH like operation. Therefore, if a Traditional HTTP client is making an implementation specific POST request for data, it would follow the same workflow as the GET operation. If the POST request is modifying content, then this method would be implemented like the PATCH operation.

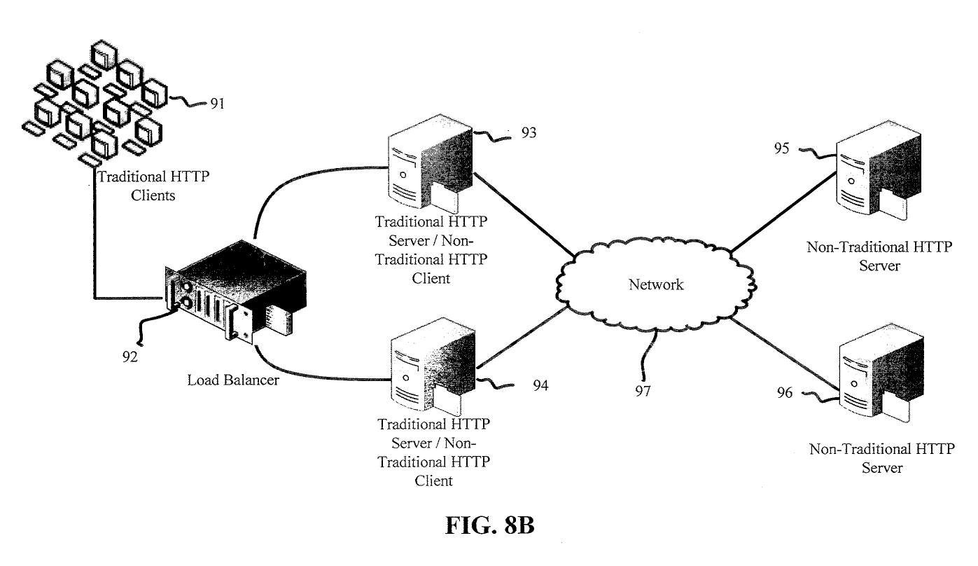

FIG. 7 depicts a conventional load balanced configuration in which one or more Traditional HTTP clients 82 are in communication with one or more Traditional HTTP servers 84, 85 through network 80 and through Load Balancer 83. As shown in FIG. 7, one or more Traditional HTTP clients 82 are configured to communicate with Load Balancer 83 through network 80. The load Balancer 83 in turn is configured to communicate with Traditional HTTP servers 84 and 85. The load balancer 83 is configured to distribute the load to a number of Traditional HTTP servers, in this example, two servers 84 and 85. This is a well-known technology which allows Web Services to scale in size.

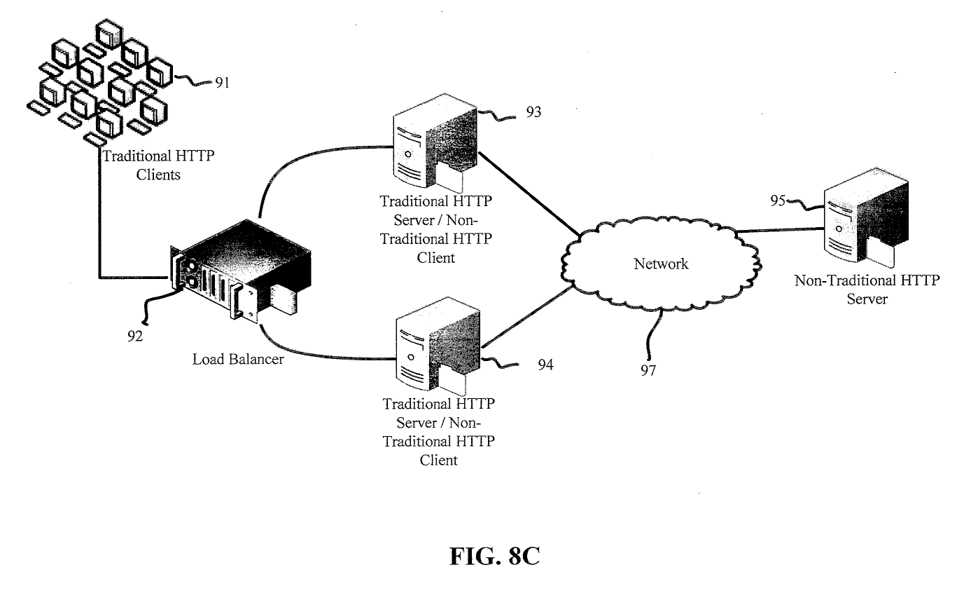

FIGS. 8A, 8B and 8C depict various configurations of one or more Traditional HTTP clients 91 in communication with one or more Non-Traditional HTTP servers 95, 96, according to various embodiments of the present invention. In one embodiment, as depicted in FIG. 8A, one or more Traditional HTTP clients 91 are configured to communicate with Traditional HTTP server 93 which is also configured to operate as a Non-Traditional HTTP client. The Traditional HTTP Server/Non-Traditional HTTP client 93 is in turn configured to communicate with one or more Non-Traditional HTTP server (in this example, two Traditional HTTP servers 95 and 96) through network 97. Although, two Non-Traditional HTTP servers 95 and 96 are depicted in FIG. 8A, any number (one, two, three, or more) of Non-Traditional HTTP servers can be connected to the Traditional HTTP server/Non-Traditional HTTP client 93 via network 97. Network 97 can be any type of network including, but not limited to, a WAN, a LAN, the Internet. Connection to network 97 can be wired or wireless.

In another embodiment, as depicted in FIG. 8B, the one or more Traditional HTTP clients 91 are configured to communicate with Load Balancer 92. Load Balancer 92 is in turn configured to communicate with one or more Traditional HTTP server (in this example, two Traditional HTTP servers 93 and 94). Each of Traditional HTTP servers 93 and 94 is also configured to operate as a Non-Traditional HTTP client. The one or more Traditional HTTP server/Non-Traditional HTTP client 93, 94 are configured to communicate with one or more Non-Traditional HTTP servers 95, 96 through network 97. For example, Traditional HTTP server/Non-Traditional HTTP client 93 can be configured to communicate with Non-Traditional HTTP server 95 or with Non-Traditional HTTP server 96 or both through network 97. Similarly, Traditional HTTP server/Non-Traditional HTTP client 94 can be configured to communicate with Non-Traditional HTTP server 95 or with Non-Traditional HTTP server 96 or both through network 97. Although two Traditional HTTP servers/Non-Traditional HTTP clients 93 and 94 are illustrated in FIG. 8B, as it can be appreciated, (two or more) Traditional HTTP servers/Non-Traditional HTTP clients can be used. Similarly, although two Non-Traditional HTTP servers 95 and 96 are illustrated in FIG. 8B, as it can be appreciated, (two or more) Non-Traditional HTTP servers can be used. In this embodiment, a load balancer 92 is used so as to split the communication (send and/or receive) load between two or more Traditional HTTP servers/Non-Traditional HTTP clients (e.g., Traditional HTTP servers/Non-Traditional HTTP clients 93 and 94). This allows, for example, higher transmission throughput through network 97, i.e., more data can be sent or received through network 97.

In operation, one or more Traditional HTTP clients 91 can send one or more requests, for example requests A and B, to load balancer 92. Load Balancer 92 forwards the one or more requests (e.g., requests A and B) to Traditional HTTP servers 93 and 94 (respectively). Traditional HTTP servers 93 and 94 which also are configured to operate as Non-Traditional HTTP clients 93 and 94 send the one or more requests (e.g., requests A and B) to Non-Traditional HTTP servers 95 and 96 using UsTP transport protocol via network (e.g., LPN) 97. For example, in the case of two requests A and B, request A may be received by Traditional HTTP server 93 which is also configured to operate as a Non-Traditional HTTP client 93. The request A may be sent by Traditional HTTP server/Non-Traditional HTTP client 93 to Non-Traditional HTTP server 95 through network 97 using UsTP transport protocol. On the other hand, request B may be received by Traditional HTTP server 94 which is also configured to operate as a Non-Traditional HTTP client 94. Request B may be sent by Traditional HTTP server/Non-Traditional HTTP client 94 to Non-Traditional HTTP server 96 through network 97 using UsTP transport protocol. For example, by splitting the requests A and B and processing the requests A and B by two distinct Traditional HTTP servers/Non-Traditional HTTP clients 93 and 94, the requests are processed faster (“in parallel”) and transmitted through network 97 in a more efficient manner. For example, in response to request A, Non-Traditional HTTP server 95 sends data (e.g., a portion of a file or the whole file) to the one or more Traditional HTTP clients 91 that sent the request. Specifically, the Non-Traditional HTTP server 95 sends transmits the data through network (e.g., LFN) 97 to Traditional HTTP server/Non-Traditional HTTP client 93 using UsTP transport protocol. The Traditional HTTP server/Non-Traditional HTTP client 93 then forward the data via the load balancer 92 to the Traditional HTTP client that sent the request A. Similarly, in response to request B, the Non-Traditional HTTP server 96 transmits the data through network (e.g., LFN) 97 to Traditional HTTP server/Non-Traditional HTTP client 94 using UsTP transport protocol. The Traditional HTTP server/Non-Traditional HTTP client 94 then forward the data via the load balancer 92 to the Traditional HTTP client that sent the request B.

This configuration allows for multiple network connections to be utilized. For example, each of the Traditional HTTP servers (e.g., Traditional HTTP servers 93 and 94) that operate also as Non-Traditional HTTP clients are provided on different networks than one or more Non-Traditional HTTP servers (e.g., Non-Traditional HTTP servers 95 and 96) which are hosting a collection of resources of a common Web Service. This allows, for example, the Web Service to be federated through a single point using a load balancer (e.g., load balancer 92).

In yet another embodiment, as depicted in FIG. 8C, one or more Traditional HTTP clients 91 are configured to communicate with Non-Traditional HTTP server 95. This configuration is similar to the configuration shown in FIG. 8B. However instead of multiple Non-Traditional HTTP servers, only one Non-Traditional HTTP server is used. The one or more Traditional HTTP clients 91 are configured to communicate with Load Balancer 92. Load Balancer 92 is in turn configured to communicate with one or more Traditional HTTP server (in this example, two Traditional HTTP servers 93 and 94). Each of Traditional HTTP servers 93 and 94 is also configured to operate as a Non-Traditional HTTP client. The one or more Traditional HTTP server/Non-Traditional HTTP client 93, 94 are configured to communicate with single Non-Traditional HTTP server 95 through network 97. For example, Traditional HTTP server/Non-Traditional HTTP client 93 can be configured to communicate with Non-Traditional HTTP server 95 through network 97. Similarly, Traditional HTTP server/Non-Traditional HTTP client 94 can be configured to communicate with Non-Traditional HTTP server 95 through network 97. Although two Traditional HTTP servers/Non-Traditional HTTP clients 93 and 94 are illustrated in FIG. 8B, as it can be appreciated, (two or more) Traditional HTTP servers/Non-Traditional HTTP clients can be used. In this embodiment, a load balancer 92 is used so as to split the communication (send and/or receive) load between two or more Traditional HTTP servers/Non-Traditional HTTP clients (e.g., Traditional HTTP servers/Non-Traditional HTTP clients 93 and 94). This allows, for example, higher transmission throughput through network 97, i.e., more data can be sent or received through network 97.

In one embodiment, the one or more Traditional HTTP clients 91 can be WebDAV clients, i.e., clients running WebDAV applications. This would allow for a file system to function over a LFN network that would be optimized for bulk data transfer with optional compression and encryption as previously described. This can be further abstracted to include a NFS client, where the NFS client would redirect requests made by a traditional HTTP client or Non-Traditional HTTP client. It can utilize the existing request methods provided by HTTP to perform I/O operations across a long fat network while not requiring additional ports or protocols to be needed beyond standard HTTP or HTTPS ports.

Referring back to FIG. 5A and FIG. 6, in one embodiment, a Traditional HTTP client 28 or Non-Traditional HTTP client 29 may use non-standard request methods. A non-standard request method can be, for example, a predefined PREALLOC request method. The PREALLOC request method does not exist in present HTTP list of known request methods which include requests such as GET, PATCH, PUT, DELETE, etc. (e.g., methods that are listed in HTTP RFC 2616). The PREALLOC request is defined herein in detail. PREALLOC request method allows HTTP server 30 to pre-allocate a file (i.e., create an empty file) so that the file can be subsequently randomly written to by using HTTP PATCH method or HTTP PUT method. Although the function of pre-allocating a file on a server to create an empty file on the server is referred to herein as “PREALLOC” any other name can be used, such as “ALLOCATEFILE” or “CREATEFILE”, or “ABCD,” etc.

In one embodiment, to pre-allocate a file on a server, the client may send the PREALLOC request to the server. As stated in the above paragraphs, a file includes a Content-Length header to identify the size in bytes of the resource or file to pre-allocate. For example, in The PREALLOC request is sent by a client (e.g., client 28) to a sever (e.g., server 30). The server can create or append (i.e., pre-allocate) a file with the requested size and respond with a status message of 200 (as defined in RFC 2616) to inform the client that the request is successful. Otherwise, the server (e.g., server 30) would provide an error number in the 400 or 500 range to inform the client (e.g., client 28) that the request is an invalid request. If the request is successful, the server (e.g., server 30) can respond to the client (e.g., client 28) with the Content-Length similar to a response of a HEAD request to identify the size of the resource.

The PREALLOC method can be used to either create or append to an existing resource. The following is an example of the client and server interaction. Prior to using the PREALLOC method, the server is informed that the PREALLOC is used as possible request. The client can then confirm that PREALLOC is indeed accepted by the server by performing a HTTP OPTIONS request. The following is an example HTTP OPTIONS response from HTTP server indicating that PREALLOC, GET, HEAD, OPTIONS are types of requests that are allowed by the server.
Accept: */*
Accept-Ranges: bytes
Allow: PREALLOC, GET, HEAD, OPTIONS
Content-Length: 0
X-Server-Copyright: abcxyz@pixia.com
DAV: 1

In the following example, a client sends a request to the server to pre-allocate a file i.e., create a file or append to the file. The PREALLOC request specifies the size or content-length to the server (e.g. Host: 127.0.0.1:80) to be preallocated for the file, in this case about 1 GB, or more exactly 1073741824 bytes. For example, the client request can be written as follows:
PREALLOC/1GB.file HTTP/1.1
Accept: */*
Host: 127.0,0.1:80
Content-Length: 1073741824
Connection: Close
User-Agent: abcxyz@pixia.com

In response to the PREALLOC request, the server sends an acknowledgement to the client that the file with the requested size or content-length 1073741824 bytes (about 1 GB) is created at the server. The server response can be as follows;
Server: abcxyz@pixia.com
Accept-Ranges: bytes
Content-Length: 1073741824
Content-Type: application/octet-stream

Referring back to FIG. 5A and FIG. 6, in one embodiment, a Traditional HTTP client 28 or Non-Traditional HTTP client 29 may use non-standard request methods. A non-standard request method can be, for example, a predefined FREESPACE request method. The FREESPACE request method does not exist in present HTTP list of known request methods which include requests such as GET, PATCH, PUT, DELETE, etc. (e.g., methods that are listed in HTTP RFC 2616). The FREESPACE request is defined herein in detail. FREESPACE request method allows HTTP server 30 to define the amount of available space in bytes that is available on a given resource. Although the function of requesting on a server to create an empty file on the server is referred to herein as “FREESPACE” any other name can be used, such as “DISKSPACE” or “FREEDISK”, or “ABCD,” etc.

In one embodiment, to obtain the total disk space or available free disk space on a storage device, the client may send the FREESPACE request to the server. For example, the FREESPACE request is sent by client 28 to a server 30. The server 30 reads the PATH_INFO, or QUERY_STRING variable to provide an alias to a storage device. For instance, if the PATH_INFO provided a location “/C-Drive”, this alias may indicate the C: disk drive is being reference. Alternately, a QUERY_STRING may have a parameter such as “?DRIVE=\\PC\Share”, which also is an indication of the storage device such as a network storage device. In either case, the server 30 may respond with a status message of 200 (as defined in RFC 2616) to inform the client 28 that the request is successful if the request is valid. Otherwise, the server 30 would provide an error number in the 400 or 500 range to inform the client 28 that the request is an invalid request. If the request is successful, the server 30 can respond to the client 28 with custom Request Meta-Variables to indicate total amount of storage capacity in bytes, along with the total free space in bytes. The Request Meta-Variables of Content-Total is referred to herein as to return the total amount of storage capability in bytes and Content-Free is referred to herein as to return the total amount of free storage space in bytes. Although the function of the Request Meta-Variable “Content-Total” is to provide the total space in bytes of the storage device any other name for the Request Meta-Variable may be used such as “Content-TotalSpace” or “TotalSpace”, or “ABCD”, etc. Similarly, although the function of the Request Meta-Variable “Content-Free” is to provide the total free space in bytes of the storage device any other name for the Request Meta-Variable may be used such as “Content-FreeSpace”, or “Free”, or “ABCD”, etc.

The FREESPACE method can be used to describe the total amount of space or free space of a storage device associated with the server. The following is an example of the client and server interaction. Prior to using the FREESPACE method, the server is informed that the FREESPACE is used as possible request. The client can then confirm that FREESPACE is indeed accepted by the server by performing a HTTP OPTIONS request. The following is an example HTTP OPTIONS response from HTTP server indicating that FREESPACE, GET, HEAD, OPTIONS are types of requests that are allowed by the server.
Accept: */*
Accept-Ranges: bytes
Allow: FREESPACE, GET, HEAD, OPTIONS
Content-length: 0
X-Server-Copyright: abcxyz@pixia.com
DAV: 1

The FREESPACE request specifies the storage device by use of a PATH_INFO parameter which is an alias to a storage device. The request is sent to a server (e.g. Host: 127.0.0.1:80) to return the total space in bytes of the storage device, along with the total free space in bytes.
FREESPACE/CDRIVE HTTP/1.1
Accept. */*
Host: 127.0,0,1:80
Connection: Close
User-Agent: abcxyz@pixia.com

In response to the FREESPACE request, the server (server 30) sends an acknowledgement to the client that the file with the total size in bytes being 1 GB and the total free space in bytes being 1 MB.
Server: abcxyz@pixia.com
Accept-Ranges: bytes
Content-Total: 1099511627776
Content-Free: 1048576
Content-Type: application/octet-stream

As it can be appreciated from the above paragraphs, there is provided a system of transmitting or receiving data over a network. The system includes a Non-Traditional HTTP client configured to communicate through a network using User Space Transport Protocol (UsTP), the Non-Traditional HTTP client being configured to operate as a HTTP or HTTPS client that does not use Transmission Control Protocol (TCP) for transmitting or receiving data. The system also includes a Non-Traditional HTTP server configured to communicate with the Non-Traditional HTTP client through the network using the User Space Transport Protocol (UsTP), the Non-Traditional HTTP server being configured to operate as a HTTP or HTTPS server that does not use Transmission Control Protocol (TCP) for transmitting or receiving data. A communication between the Non-Traditional HTTP client and the Non-Traditional server through the network using User Space Transport Protocol (UsTP) is established with a bandwidth greater than a bandwidth that is achieved using TCP.

In one embodiment, the User Space Transport Protocol (UsTP) includes User Datagram Protocol (UDP), User Data Transfer protocol (UDT), ASPERA® FASP™ protocol, or Low Extra Delay Background Transport (LEDBAT) protocol. In one embodiment, the network is a wide area network, a local area network, or the internet, or any combination thereof. In one embodiment, the network is a long fat network (LFN) having a relatively high latency with a round trip time (RTT) equal to or greater than 100 ms. In one embodiment, the Non-Traditional HTTP server is configured to implement a web service. In one embodiment, the web service includes representational state transfer (REST) web service.

In one embodiment, the Non-Traditional HTTP client is further configured to operate as a Traditional HTTP server, the Traditional HTTP server being configured to operate as a HTTP or HTTPS server that uses Transmission Control Protocol (TCP) for transmitting data to or receiving data from a Traditional HTTP client, the Traditional HTTP client being configured to operate as a HTTP or HTTPS client that uses Transmission Control Protocol (TCP) for transmitting and receiving data. The Non-Traditional HTTP server can be configured to transmit data to the Traditional client is a compressed form or encrypted form or both. The system may also include a plurality of Non-Traditional HTTP servers configured to communicate with the Non-Traditional HTTP client through the network using the User Space Transport Protocol (UsTP), the plurality of Non-Traditional HTTP servers being configured to operate as HTTP or HTTPS servers that do not use Transmission Control Protocol (TCP) for transmitting data to or receiving data. In one embodiment, the Non-Traditional HTTP server can be further configured to operate as a Traditional HTTP client, the Traditional HTTP client being configured to operate as a HTTP or HTTPS client that uses Transmission Control Protocol (TCP) for transmitting data to or receiving data from a Traditional HTTP server, the Traditional HTTP server being configured to communicate with the Non-Traditional HTTP server. In one embodiment, the Traditional HTTP server is configured to host OGC WMS service or a WEBDAV service.

In one embodiment, the Traditional HTTP client is configured to send a request to the Traditional HTTP server using the Transmission Control Protocol (TCP), the Traditional HTTP server is configured to receive the request and translate the request to the Non-Traditional HTTP client. In one embodiment, the Non-Traditional HTTP client is further configured to transmit the request through the network using the User Space Transport Protocol (UsTP) to the Non-Traditional HTTP server. In one embodiment, the Non-Traditional HTTP server is configured to receive the request and return a resource from a file or web service in the Non-Traditional HTTP server. In one embodiment, the Non-Traditional HTTP server transmits the resource via the network using User Space Transport Protocol (UsTP) to the Non-Traditional HTTP client. In one embodiment, the Non-Traditional HTTP client which is configured to operate as a Traditional HTTP server is further configured to receive the resource and translate the resource to the Traditional HTTP server. In one embodiment, the Traditional HTTP server is configured to send the request to the Traditional HTTP client through Transmission Control Protocol (TCP).

In one embodiment, the request is an HTTP HEAD request, or an HTTP GET request, or an HTTP PATCH request, or HTTP POST request any combination thereof. In response to the HTTP HEAD request, the Non-Traditional server transmits to the Traditional HTTP client a response including a Content-Length information including a total size of data requested. In response to the HTTP GET request or to the HTTP PATCH request, the Non-Traditional server transmits to the Traditional HTTP client a response including a portion of a data file or the whole data file containing requested data.

In one embodiment, the non-Traditional server is configured to transmit the requested data as a plurality of portions. The Non-Traditional server can be configured to encrypt the plurality of data portions. The Non-Traditional server can be further configured to compress the plurality of data portions. In one embodiment, the Traditional HTTP client operates as a Network File System (NFS) Traditional HTTP client.

As it can be appreciated, there is also provided a system of transmitting and receiving data over a network. The system includes a plurality of Non-Traditional HTTP clients configured to communicate through a network using User Space Transport Protocol (UsTP), the plurality of Non-Traditional HTTP clients being configured to operate as HTTP or HTTPS clients that do not use Transmission Control Protocol (TCP) for transmitting or receiving data. The system further includes a plurality of Non-Traditional HTTP servers configured to communicate with the plurality of Non-Traditional HTTP clients through the network using the User Space Transport Protocol (UsTP), the plurality of Non-Traditional HTTP servers being configured to operate as HTTP or HTTPS servers that do not use Transmission Control Protocol (TCP) for transmitting or receiving data. A communication between the Non-Traditional HTTP client and the Non-Traditional server through the network using User Space Transport Protocol (UsTP) is established with a bandwidth greater than a bandwidth that is achieved using TCP.

In one embodiment, the plurality of Non-Traditional HTTP clients are configured to operate as a plurality of Traditional HTTP servers, the plurality of Traditional HTTP servers being configured to operate as HTTP or HTTPS servers that use Transmission Control Protocol (TCP) for transmitting and receiving data to and from one or more Traditional HTTP clients, the one or more Traditional HTTP clients being configured to operate as one or more HTTP or HTTPS clients that use Transmission Control Protocol (TCP) for transmitting and receiving data.

In one embodiment, the system further includes a load balancer configured to communicate with the one or more Traditional HTTP clients and the plurality of Non-Traditional HTTP clients, wherein the load balancer is configured to split a communication from the one or more Traditional HTTP clients between the plurality of Non-Traditional HTTP clients that are configured to operate as a plurality of Traditional HTTP servers.

As it can be appreciated from the above paragraphs, there is also provided a computer-implemented method of transmitting data over a network, the method being implemented in a computer system comprising one or more computer processor units configured to execute one or more computer program modules. The method includes receiving, by a Non-Traditional HTTP server implemented on the computer system, a request from a Non-Traditional HTTP client through a network, the Non-Traditional HTTP server being configured to operate as a HTTP or HTTPS server that does not use Transmission Control Protocol (TCP) for transmitting or receiving data, the Non-Traditional HTTP client being configured to operate as a HTTP or HTTPS client that does not use Transmission Control Protocol (TCP) for transmitting or receiving data, the Non-Traditional HTTP server and the Non-Traditional HTTP client communicating through the network using User Space Transport Protocol (UsTP); and determining by the Non-Traditional HTTP server whether the request is valid. In the request is determined to be invalid, sending, by the Non-Traditional HTTP server, an error message to the Non-Traditional HTTP client through the network over User Space Transport Protocol (UsTP). If the request is determined to be valid, sending by the Non-Traditional HTTP server, requested data to the Non-Traditional HTTP client through the network over User Space Transport Protocol (UsTP).

In one embodiment, receiving by the Non-Traditional HTTP server the request includes receiving by a Traditional HTTP server the request, the Traditional HTTP server being configured to operate as a HTTP or HTTPS server that uses Transmission Control Protocol (TCP) for transmitting or receiving data, the Traditional HTTP server being further configured to operate as the Non-Traditional HTTP client; and determining by the Traditional HTTP server whether the request is valid. If the request is determined to be invalid, sending, by the Traditional HTTP server, an error message to the Traditional HTTP client using Transmission Control Protocol (TCP). If the request is determined to be valid, translating, by the Traditional HTTP server, the request to the Non-Traditional HTTP client. If the request is determined to be invalid: translating the error message by the Non-Traditional HTTP client to the Traditional HTTP server, and forwarding the error message, by the Traditional HTTP server, to the Traditional HTTP client using Transmission Control Protocol (TCP) If the request is determined to valid: translating the requested data, by the Non-Traditional HTTP client, to a Traditional HTTP server, the Traditional HTTP server being configured to operate as a HTTP or HTTPS server that uses Transmission Control Protocol (TCP) for transmitting or receiving data, the Traditional HTTP server being further configured to operate as the Non-Traditional HTTP client; and forwarding the requested data, by the Traditional HTTP server, to the Traditional HTTP client using Transmission Control Protocol (TCP).

In one embodiment, the User Space Transport Protocol (UsTP) includes User Datagram Protocol (UDP), User Data Transfer protocol (UDT), ASPERA® FASP™ protocol, or Low Extra Delay Background Transport (LEDBAT) protocol. In one embodiment, the network is a wide area network, a local area network, or the internet, or any combination thereof. In one embodiment, the network is a long fat network (LFN) having a relatively high latency with a round trip time (RTT) equal to or greater than 100 ms.

In one embodiment, sending by the Non-Traditional HTTP server, requested data to the Non-Traditional HTTP client includes sending by a web service implemented on the Non-Traditional HTTP server. In one embodiment, the web service includes representational state transfer (REST) web service, Open Geospatial Consortium Web Mapping Service (OGC:WMS) web service, or Open Geospatial Consortium Wide Area Motion Imagery (OGC:WAMI) web service.

In one embodiment, sending by the Non-Traditional HTTP server, requested data to the Non-Traditional HTTP client includes sending by the Non-Traditional HTTP server the requested data to the Traditional client in a compressed form or encrypted form or both. In one embodiment, sending, by the Non-Traditional HTTP server, requested data to the Non-Traditional HTTP client includes sending to the Non-Traditional HTTP client a response including a Content-Length information including a total size of data requested. In one embodiment, the request is an HTTP HEAD request, or an HTTP GET request, or an HTTP PATCH request, or a HTTP POST request any combination thereof. In one embodiment, sending, by the Non-Traditional HTTP server, requested data to the Non-Traditional HTTP client includes sending a response including a portion of a data file or the whole data file containing the requested data. In one embodiment, sending the response includes sending the requested data as a plurality of data portions. In one embodiment, sending the plurality of data portions includes encrypting the plurality of data portions. In one embodiment, sending the plurality of data portions compressing the plurality of data portions.

In one embodiment, receiving by the Non-Traditional HTTP server the request includes receiving by, a load balancer, the request from one or more Traditional HTTP clients, the load balancer forwarding the request to one or more Traditional HTTP servers, the one or more Traditional HTTP servers being configured to operate as HTTP or HTTPS servers that use Transmission Control Protocol (TCP) for transmitting or receiving data, the one or more Traditional HTTP servers being further configured to operate as one or more Non-Traditional HTTP clients, the one or more non-Traditional HTTP clients being configured to operate as HTTP or HTTPS clients that do not use Transmission Control Protocol (TCP) for transmitting or receiving data; translating the requested data, by the one or more Traditional HTTP servers, to the one or more Non-Traditional HTTP clients, and forwarding the requested data, by the one or more Non-Traditional HTTP clients, to the Non-Traditional HTTP server through the network over User Space Transport Protocol (UsTP).

As it can be appreciated from the above paragraphs, there is also provided a computer-implemented method of pre-allocating a data file using an HTTP request, the method being implemented in a computer system comprising one or more computer processor units configured to execute one or more computer program modules. The method includes sending, by an HTTP client, a request to an HTTP server to create or append an empty file, the request including a Content-Length header that identifies a size of the empty file. The method may further include receiving the request by the HTTP server; and determining by the HTTP server whether the request is valid. If the request is determined to be invalid by the HTTP server, the HTTP server sends an error message to the HTTP client. If the request is determined to be valid, the HTTP server sends a message to the HTTP client that the request is successful, the message containing the Content-Length included in the request.

In one embodiment, sending the request includes sending a series of code lines including an address of the HTTP server, a user identification, and the content-Length header. In one embodiment, sending by the HTTP client the request to the HTTP server includes sending by a Traditional HTTP client the request to a Non-Traditional HTTP server, the Non-Traditional HTTP server being configured to operate as a HTTP or HTTPS server that does not use Transmission Control Protocol (TCP) for transmitting or receiving data, the Traditional HTTP client being configured to operate as a HTTP or HTTPS client that uses Transmission Control Protocol (TCP) for transmitting or receiving data.

In one embodiment, sending by the Traditional HTTP client to the Non-Traditional HTTP server includes sending, by the Traditional HTTP client, the request to a Traditional HTTP server, the Traditional HTTP server being configured to operate as a HTTP or HTTPS client that uses Transmission Control Protocol (TCP) for transmitting or receiving data, the Traditional HTTP server being further configured to operate as a Non-Traditional HTTP client, the Non-Traditional HTTP client being configured to operate as a HTTP or HTTPS client that does not use Transmission Control Protocol (TCP) for transmitting or receiving data; translating the request from Traditional HTTP server to the Non-Traditional HTTP client; and transmitting, by the Non-Traditional HTTP client, the request to the the Non-Traditional HTTP server through a network over User Space Transport Protocol (UsTP).

In one embodiment, the User Space Transport Protocol (UsTP) includes User Datagram Protocol (UDP), User Data Transfer protocol (UDT), ASPERA® FASP™ protocol, or Low Extra Delay Background Transport (LEDBAT) protocol. In one embodiment, the network can be a wide area network, a local area network, or the internee, or any combination thereof. In one embodiment, the network is a long fat network (LFN) having a relatively high latency with a round trip time (RTT) equal to or greater than 100 ms.

As it can be appreciated from the above paragraphs, there is also provided a computer-implemented method of requesting available space using an HTTP request, the method being implemented in a computer system comprising one or more computer processor units configured to execute one or more computer program modules. The method includes sending, by an HTTP client, a request to an HTTP server to request an amount of total storage space on the storage device or an amount of free storage space available on the storage device associated with the server, or both, the request including a location of the storage device. The method may further include receiving the request by the HTTP server; and determining by the HTTP server whether the request is valid. If the request is determined to be invalid by the HTTP server, the HTTP server sends an error message to the HTTP client. If the request is determined to be valid, the HTTP server sends a message to the HTTP client that the request is successful, an amount of total storage space on the storage device or an amount of free storage space available on the storage device, or both.

In one embodiment, sending the request includes sending a series of code lines including an address of the HTTP server, a user identification, and the location of the storage device. In one embodiment, sending by the HTTP client the request to the HTTP server includes sending by a Traditional HTTP client the request to a Non-Traditional HTTP server, the Non-Traditional HTTP server being configured to operate as a HTTP or HTTPS server that does not use Transmission Control Protocol (TCP) for transmitting or receiving data, the Traditional HTTP client being configured to operate as a HTTP or HTTPS client that uses Transmission Control Protocol (TCP) for transmitting or receiving data.

In one embodiment, sending by the Traditional HTTP client to the Non-Traditional HTTP server includes sending by the Traditional HTTP client the request to a Traditional HTTP server, the Traditional HTTP server being configured to operate as a HTTP or HTTPS client that uses Transmission Control Protocol (TCP) for transmitting or receiving data, the Traditional HTTP server being further configured to operate as a Non-Traditional HTTP client, the Non-Traditional HTTP client being configured to operate as a HTTP or HTTPS client that does not use Transmission Control Protocol (TCP) for transmitting or receiving data; translating the request from the Traditional HTTP server to the Non-Traditional HTTP client; and transmitting, by the Non-Traditional HTTP client, the request to the Non-Traditional HTTP server through a network over User Space Transport Protocol (UsTP).

In one embodiment, the User Space Transport Protocol (UsTP) includes User Datagram Protocol (UDP), User Data Transfer protocol (UDT), ASPERA® FASP™ protocol, or Low Extra Delay Background Transport (LEDBAT) protocol. In one embodiment, the network is a wide area network, a local area network, or the internet, or any combination thereof. In one embodiment, the network is a long fat network (LFN) having a relatively high latency with a round trip time (RTT) equal to or greater than 100 ms.

In some embodiments, programs for performing methods in accordance with embodiments of the invention can be embodied as program products in a computer such as a personal computer or server or in a distributed computing environment comprising a plurality of computers. The computer may include, for example, a desktop computer, a laptop computer, a handheld computing device such as a PDA, a tablet, etc. The computer program products may include a computer readable medium or storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash card), PCMCIA memory card, smart card, or other media. Alternatively, a portion or the whole computer program product can be downloaded from a remote computer or server via a network such as the internet, an ATM network, a wide area network (WAN) or a local area network (LAN).

Stored on one or more of the computer readable media, the program may include software for controlling both the hardware of a general purpose or specialized computer or processor. The software also enables the computer or processor to interact with a user via output devices such as a graphical user interface, head mounted display (HMD), etc. The software may also include, but is not limited to, device drivers, operating systems and user applications.

Alternatively, instead or in addition to implementing the methods described above as computer program product(s) (e.g., as software products) embodied in a computer, the method described above can be implemented as hardware in which for example an application specific integrated circuit (ASIC) or graphics processing unit or units (GPU) can be designed to implement the method or methods of the present invention.

Although the various steps of the above method(s) are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A computer-implemented method of transmitting data over a network, the method being implemented in a computer system comprising one or more computer processor units configured to execute one or more computer program modules, the method comprising:
receiving, by a Non-Traditional HTTP server implemented on the computer system, a request from a Non-Traditional HTTP client through a network, the Non-Traditional HTTP server being configured to operate as a HTTP or HTTPS server that does not use Transmission Control Protocol (TCP) for transmitting or receiving data, the Non-Traditional HTTP client being configured to operate as a HTTP or HTTPS client that does not use Transmission Control Protocol (TCP) for transmitting or receiving data, the Non-Traditional HTTP server being configured to operate as a Traditional HTTP client and the Traditional HTTP server being configured to operate as Non-Traditional HTTP client, the Non-Traditional HTTP server and the Non-Traditional HTTP client communicating through the network using User Space Transport Protocol (UsTP);
determining by the Non-Traditional HTTP server whether the request is valid,
if the request is determined to be invalid, sending, by the Non-Traditional HTTP server, an error message to the Non-Traditional HTTP client through the network over User Space Transport Protocol (UsTP);
if the request is determined to be valid, sending by the Non-Traditional HTTP server, requested data to the Non-Traditional HTTP client through the network over User Space Transport Protocol (UsTP).

2. The method of claim 1, further comprising:
receiving by the Traditional HTTP server the request, the Traditional HTTP server being configured to operate as a HTTP or HTTPS server that uses Transmission Control Protocol (TCP) for transmitting or receiving data, the Traditional HTTP server being further configured to operate as the Non-Traditional HTTP client;
determining by the Traditional HTTP server whether the request is valid;
if the request is determined to be invalid, sending, by the Traditional HTTP server, an error message to the Traditional HTTP client using Transmission Control Protocol (TCP);
if the request is determined to be valid, translating, by the Traditional HTTP server, the request to the Non-Traditional HTTP client.

3. The method of claim 2, further comprising, if the request is determined to be invalid:
translating the error message by the Non-Traditional HTTP client to the Traditional HTTP server, and
forwarding the error message, by the Traditional HTTP server, to the Traditional HTTP client using Transmission Control Protocol (TCP).

4. The method of claim 1, further comprising, if the request is determined to be valid:
translating the requested data, by the Non-Traditional HTTP client, to the Traditional HTTP server, the Traditional HTTP server being configured to operate as a HTTP or HTTPS server that uses Transmission Control Protocol (TCP) for transmitting or receiving data, the Traditional HTTP server being further configured to operate as the Non-Traditional HTTP client; and
forwarding the requested data, by the Traditional HTTP server, to the Traditional HTTP client using Transmission Control Protocol (TCP).

5. The method of claim 1, wherein the User Space Transport Protocol (UsTP) comprises User Datagram Protocol (UDP), User Data Transfer protocol (UDT), ASPERA® FASP™ protocol, or Low Extra Delay Background Transport (LEDBAT) protocol.

6. The method of claim 1, wherein the network is a wide area network, a local area network, or the internet, or any combination thereof.

7. The method of claim 1, wherein the network is a long fat network (LFN) having a relatively high latency with a round trip time (RTT) equal to or greater than 100 ms.

8. The method of claim 1, wherein sending by the Non-Traditional HTTP server, requested data to the Non-Traditional HTTP client comprises sending by a web service implemented on the Non-Traditional HTTP server.

9. The method of claim 8, wherein the web service includes representational state transfer (REST) web service, Open Geospatial Consortium Web Mapping Service (OGC:WMS) web service, or Open Geospatial Consortium Wide Area Motion Imagery (OGC:WAMI) web service.

10. The method of claim 1, wherein sending by the Non-Traditional HTTP server, requested data to the Non-Traditional HTTP client comprises sending by the Non-Traditional HTTP server the requested data to the Traditional HTTP client in a compressed form or encrypted form or both.

11. The method of claim 1, wherein sending, by the Non-Traditional HTTP server, requested data to the Non-Traditional HTTP client comprises sending by the Non-Traditional HTTP server to the Non-Traditional HTTP client a response including a Content-Length information including a total size of data requested.

12. The method of claim 1, wherein the request is an HTTP HEAD request, an HTTP GET request, an HTTP PATCH request, or HTTP POST request, or any combination thereof.

13. The method of claim 12, wherein sending, by the Non-Traditional HTTP server, requested data to the Non-Traditional HTTP client comprises sending a response including a portion of a data file containing the requested data or the whole data file containing the requested data.

14. The method of claim 13, wherein sending the response comprises sending the requested data as a plurality of data portions.

15. The method of claim 14, wherein sending the plurality of data portions comprises encrypting the plurality of data portions.

16. The method of claim 14, wherein sending the plurality of data portions comprises compressing the plurality of data portions.

17. The method of claim 1, further comprising:
translating, by the Non-Traditional HTTP server, the request to the Traditional HTTP client, the Traditional HTTP client being configured to operate as a HTTP or HTTPS client that uses Transmission Control Protocol (TCP) for transmitting or receiving data, the Non-Traditional HTTP server being configured to operate as the Traditional HTTP client; and
forwarding the request, by the Traditional HTTP client, to a Traditional HTTP server using Transmission Control Protocol (TCP).

18. The method of claim 17, further comprising sending, in response to the request, the requested data by the Traditional HTTP server to the Traditional HTTP client over the Transmission Control Protocol (TCP).

19. The method of claim 18, further comprising translating the requested data, by the Traditional HTTP client, to the Non-Traditional HTTP server, the Non-Traditional HTTP server being configured to operate as the Traditional HTTP client; and
sending, by the Non-Traditional HTTP server, the requested data to the Non-Traditional HTTP client through the network over the User Space Transport Protocol (UsTP).

20. The method of claim 1, wherein receiving by the Non-Traditional HTTP server the request comprises:
receiving by, a load balancer, the request from one or more Traditional HTTP clients, the load balancer forwarding the request to one or more Traditional HTTP servers, the one or more Traditional HTTP servers being configured to operate as HTTP or HTTPS servers that use Transmission Control Protocol (TCP) for transmitting or receiving data, the one or more Traditional HTTP servers being further configured to operate as one or more Non-Traditional HTTP clients, the one or more non-Traditional HTTP clients being configured to operate as HTTP or HTTPS clients that do not use Transmission Control Protocol (TCP) for transmitting or receiving, data;
translating the requested data, by the one or more Traditional HTTP servers, to the one or more Non-Traditional HTTP clients, and
forwarding the requested data, by the one or more Non-Traditional HTTP clients, to the Non-Traditional HTTP server through the network over User Space Transport Protocol (UsTP).
